(19) United States
(12) Patent Application Publication
(10) Pub. No.: US 2024/0091798 A1
(43) Pub. Date: Mar. 21, 2024

(54) MICROBUBBLE SPRAY HEAD AND WASHING APPARATUS WITH SAME

(71) Applicants: QINGDAO HAIER DRUM WASHING MACHINE CO., LTD., Qingdao, Shandong (CN); Haier Smart Home Co., Ltd., Qingdao, Shandong (CN)

(72) Inventors: Zhiqiang ZHAO, Qingdao (CN); Sheng XU, Qingdao (CN)

(73) Assignees: QINGDAO HAIER DRUM WASHING MACHINE CO., LTD., Qingdao, Shandong (CN); Haier Smart Home Co., Ltd., Qingdao, Shandong (CN)

(21) Appl. No.: 17/768,024

(22) PCT Filed: Sep. 27, 2020
(86) PCT No.: PCT/CN2020/118079

§ 371 Date: Apr. 11, 2022

(30) Foreign Application Priority Data
Oct. 10, 2019 (CN) 201910959563.6
Oct. 10, 2019 (CN) 201910959597.5
Oct. 10, 2019 (CN) 201910960304.5
Oct. 10, 2019 (CN) 201910960312.X
Oct. 17, 2019 (CN) 201910997550.8
Oct. 31, 2019 (CN) 201911054299.8
Oct. 31, 2019 (CN) 201911054303.0

(51) Int. Cl. B05B 7/04; B01F 23/231; B01F 23/2326; B01F 23/2373; B01F 25/312; D06F 39/08

(52) U.S. Cl. CPC B05B 7/0425; B01F 23/231231; B01F 23/2326; B01F 23/2373; B01F 25/3121; B01F 25/31242; B01F 25/312512; D06F 39/088

(57) ABSTRACT

A microbubble spray head and a washing apparatus with the same. The microbubble spray head includes a spray pipe, where the spray pipe is of an integrated or two-part hollow pipe structure, an air inlet channel is provided in the spray pipe, the spray pipe is configured to enable water flow to generate negative pressure in the spray pipe, external air is sucked into the spray pipe via the air inlet channel by the negative pressure and is mixed with water flow in the spray pipe to form bubble water; and a bubbler, where the bubbler is fixed at the outlet end of the spray pipe and is configured to be capable of forming microbubble water when the bubble water flows through the bubbler. The microbubble spray head has good microbubble generation performance and low manufacturing costs.

### CROSS-REFERENCE TO RELATED APPLICATIONS

The present application claims priority from the following prior applications:
Chinese patent application for invention with the application No. “201910959597.5” filed on Oct. 10, 2019;
Chinese patent application for invention with the application No. “201910960304.5” filed on Oct. 10, 2019;
Chinese patent application for invention with the application No. “201910960312.X” filed on Oct. 10, 2019;
Chinese patent application for invention with the application No. “201910997550.8” filed on Oct. 17, 2019;
Chinese patent application for invention with the application No. “201911054303.0” filed on Oct. 31, 2019;
Chinese patent application for invention with the application No. “201910959563.6” filed on Oct. 31, 2019; and
Chinese patent application for invention with the application No. “201911054299.8” filed on Oct. 31, 2019. The contents of these applications are incorporated into the present application by reference in their entirety.

### FIELD

The present disclosure relates to a micro-bubble generation device, and specifically relate to a micro-bubble spray head and a washing apparatus having the micro-bubble spray head.

### BACKGROUND

Micro-bubbles usually refer to tiny bubbles with a diameter below 50 micrometers (μm) during bubbles generation. Micro-bubbles may also be called micro-/nano-bubbles, micron-bubbles or nano-bubbles depending on their ranges of diameter. Due to their low buoyancy in a liquid, micro-bubbles stay for a longer time in the liquid. Furthermore, the micro-bubbles will shrink in the liquid until they finally break up, generating smaller nano-bubbles. In this process, a rising speed of the bubbles becomes slow since the bubbles become smaller, thus resulting in a high melting efficiency. When the micro-bubbles break up, high-pressure and high-temperature heat is locally generated, thereby destroying foreign objects such as organic matters floating in the liquid or adhering to objects. In addition, the shrinkage process of micro-bubbles is also accompanied by an increase in negative charges. A peak state of negative charges is usually when the diameter of the micro-bubbles is 1-30 microns, so it is easy for them to adsorb positively charged foreign matters floating in the liquid. The result is that the foreign matters are adsorbed by the micro-bubbles after they are destroyed due to the breaking up of the micro-bubbles, and then slowly float to a surface of the liquid. These properties make the micro-bubbles have extremely strong cleaning and purifying abilities. At present, micro-bubbles have been widely used in washing apparatuses such as clothing washing machines.

In order to produce micro-bubbles, micro-bubble generation devices of different structures have been developed. For example, Chinese patent application for invention (CN107321204A) discloses a micro-bubble generator. The micro-bubble generator includes a shell with two open ends; a water inflow pipe is connected to a first end of the shell, and a vortex column, a vortex column shell, a gas-liquid mixing pipe and a hole mesh positioned at a second end of the shell are arranged in sequence inside the shell in a water flow direction. The gas-liquid mixing pipe is sequentially formed with an accommodation cavity, an air flow part, an acceleration part and a circulation part that communicate with each other from head to tail. The vortex column shell and the vortex column located in the vortex column shell are positioned in the accommodation cavity; an air inlet is provided on a pipe wall of the air flow part; an inner wall of the air flow part protrudes toward the direction of the accommodation cavity, forming a funnel-shaped protruding part; a slit is formed between a large mouth end of the funnel-shaped protruding part and the conical vortex column shell so that the air entering from the air inlet can enter the air flow part; an inner diameter of the acceleration part gradually increases toward the direction of the tail. A water flow flows through the vortex column to form a high-speed rotating water flow inside the vortex column shell, and the high-speed rotating water flow flows out from an outlet of the vortex column shell and then enters a funnel-shaped space enclosed by the protruding part. Air is sucked in from the air inlet by a negative pressure formed around the water flow and mixed with the water flow before entering the acceleration part. Because of a conical surface of the vortex column shell and a pressure difference formed due to the inner diameter of the acceleration part gradually increasing toward the direction of the tail, the water flow mixed with a large amount of air (forming bubble water) flows in an accelerated state, and the bubble water flows to the hole mesh through the circulation part. The bubble water is cut and mixed by fine holes in the hole mesh to produce micro-bubble water containing a large number of micro-bubbles.

Chinese patent application for invention (CN107583480A) also discloses a micro-bubble generator. The micro-bubble generator includes a shell with two open ends; a water inflow pipe is connected to a first end of the shell, and a pressurizing pipe, a bubble generation pipe and a hole mesh positioned at a second end of the shell are arranged in sequence inside the shell in a water flow direction. From a first end to a second end, the bubble generation pipe is sequentially formed with an accommodation cavity, a gas-liquid mixing part, and an expansion and guide part. The pressurizing pipe is received in the accommodation cavity, and the pressurizing pipe has a conical end facing the accommodation cavity; in the gas-liquid mixing part, a conical gas-liquid mixing space whose size gradually decreases in a direction from the first end to the second end is formed; and an expansion and guide space whose size increases in the direction from the first end to the second end is formed in the expansion and guide part. An air inflow passage is formed on a pipe wall of the bubble generation pipe, a gap is formed between an inner wall of the gas-liquid mixing part and an outer wall of the pressurizing pipe so as to communicate with the air inflow passage on the pipe wall of the bubble generation pipe, and a water outlet of the pressurizing pipe is arranged in a water inlet of the gas-liquid mixing part. The water flow flows through the pressurizing pipe and is pressurized to form a high-speed water flow. The high-speed water flow flows out from the water outlet of the pressurizing pipe and then enters the gas-liquid mixing cavity to form a negative pressure in the gas-liquid mixing cavity. The negative pressure sucks a large amount of air into the water flow through the air inflow passage and enables the air and water to mix with each other to form bubble water. The bubble water flows from the expansion and guide part to the hole mesh, and the bubble water is mixed and cut by the fine holes of the hole mesh to form micro-bubble water.

The above two kinds of micro-bubble generators each have at least five independent components: a shell, a water inflow pipe, a vortex column and a vortex column shell or a pressurizing pipe, a gas-liquid mixing pipe or a bubble generation pipe, and a hole mesh. These components all need to be designed with specific mating or connection structures so that all these components can be assembled together and the assembled micro-bubble generator can work reliably. In addition, in order to allow air to be sucked into the micro-bubble generator from the outside, an air passage needs to be provided on both the shell and the gas-liquid mixing pipe or the bubble generation pipe. Therefore, the components and structures of such micro-bubble generators are relatively complicated, and the manufacturing cost is also high.

Accordingly, there is a need in the art for a new technical solution to solve the above problem.

### SUMMARY

In order to solve the above problem in the prior art, that is, to solve the technical problem that existing micro-bubble generators have a complicated structure and the manufacturing cost is high, the present disclosure provides a micro-bubble spray head, which includes: a spray pipe, which is a one-piece or two-piece hollow pipe structure; in which an air inflow passage is provided on the spray pipe, and the spray pipe is configured such that water flow can generate a negative pressure in the spray pipe, and that outside air can be sucked into the spray pipe through the air inflow passage by means of the negative pressure and mix with the water flow in the spray pipe to form bubble water; and a bubbler, which is fixed at an outlet end of the spray pipe and which is configured to be capable of forming micro-bubble water when the bubble water flows through the bubbler. Therefore, as compared with the micro-bubble generators having many components in the prior art, the micro-bubble spray head of the present disclosure not only has good performance of micro-bubble generation, but also has the number of components thereof greatly reduced, thus also eliminating the need for designing and manufacturing connection structures between the components and significantly reducing the manufacturing cost of the entire micro-bubble spray head.

Specifically, in order to solve the above problem, in a first embodiment, the present disclosure provides a micro-bubble spray head, which includes an one-piece spray pipe and a bubbler; at-least-one-stage diameter-decreased conical part is provided in the one-piece spray pipe in a water flow direction, a spray hole is formed at a top of a downstream end of the at-least-one-stage diameter-decreased conical part, and the spray hole is configured such that a water flow flowing through the at-least-one-stage diameter-decreased conical part generates a negative pressure in the one-piece spray pipe after the water flow is sprayed from the spray hole; a flow disturbing part is provided on an inner wall of the at-least-one-stage diameter-decreased conical part; at least one air inflow hole is provided on a pipe wall of the one-piece spray pipe, and the at least one air inflow hole is positioned close to the spray hole so that air is sucked into the one-piece spray pipe through the at least one air inflow hole under the action of the negative pressure and mix with the water flow to produce bubble water; and the bubbler is fixed to the outlet end of the one-piece spray pipe and is configured to be capable of forming micro-bubble water when the bubble water flows through the bubbler.

In a preferred technical solution of the above micro-bubble spray head, the flow disturbing part is positioned on an inner wall of the diameter-decreased conical part of a most downstream stage of the at-least-one-stage diameter-decreased conical part.

In a preferred technical solution of the above micro-bubble spray head, the flow disturbing part is at least one radial protrusion arranged on the inner wall of the at-least-one-stage diameter-decreased conical part or at least one flow disturbing rib extending longitudinally along the inner wall of the at-least-one-stage diameter-decreased conical part.

In a preferred technical solution of the above micro-bubble spray head, the at least one air inflow hole includes a plurality of air inflow holes arranged in a circumferential direction of the pipe wall of the one-piece spray pipe.

In a preferred technical solution of the above micro-bubble spray head, the bubbler includes a hole mesh and a hole mesh skeleton, and the hole mesh is attached to the outlet end of the one-piece spray pipe through the hole mesh skeleton.

In a preferred technical solution of the above micro-bubble spray head, the hole mesh skeleton is provided with at least one overflow hole, and the at least one overflow hole is positioned close to the hole mesh.

In a preferred technical solution of the above micro-bubble spray head, the hole mesh has at least one fine hole having a diameter reaching a micron scale.

In a preferred technical solution of the above micro-bubble spray head, the hole mesh includes plastic fence, metal mesh, or macromolecular material mesh.

In a preferred technical solution of the above micro-bubble spray head, the bubbler further includes a pressure ring, and the pressure ring is configured to be positioned between the hole mesh skeleton and the outlet end of the one-piece spray pipe to fix the hole mesh.

It can be understood by those skilled in the art that in the technical solution of the present disclosure, the micro-bubble spray head includes a one-piece spray pipe and a bubbler installed at an outlet end of the one-piece spray pipe. At-least-one-stage diameter-decreased conical part is provided in the one-piece spray pipe in a water flow direction, and a flow disturbing part is provided on an inner wall of the at-least-one-stage diameter-decreased conical part. The water flow is accelerated in the at-least-one-stage diameter-decreased conical part, whereas the flow disturbing part increases the turbulence of the water; the accelerated water flow is sprayed in an expanded state from the spray hole into a downstream passage in the one-piece spray pipe, and generates a negative pressure in the downstream passage. At least one air inflow hole is provided on the pipe wall of the one-piece spray pipe. Under the action of negative pressure, a large amount of air is sucked into the one-piece spray pipe from the outside through these air inflow holes and mixes with water to produce bubble water containing a large number of bubbles. The bubble water then flows through the bubbler located at the outlet end of the one-piece spray pipe to be cut and mixed by the bubbler, thereby producing micro-bubble water containing a large number of micro-bubbles. In the technical solution of the micro-bubble spray head of the present disclosure, the function of generating micro-bubbles is realized by the at-least-one-stage diameter-decreased conical part designed in the one-piece spray pipe, the flow disturbing part located on the inner wall of the at-least-one-stage diameter-decreased conical part, and the bubbler fixed at the outlet end of the one-piece spray pipe. Therefore, as compared with the micro-bubble generators having many components in the prior art, the micro-bubble spray head of the present disclosure not only has good performance of micro-bubble generation, but also has the number of components thereof greatly reduced, thus also eliminating the need for designing and manufacturing connection structures between the components and significantly reducing the manufacturing cost of the entire micro-bubble spray head.

Preferably, the flow disturbing part is positioned on an inner wall of the diameter-decreased conical part of a most downstream stage of the at-least-one-stage diameter-decreased conical part. The flow disturbing part can be at least one radial protrusion arranged on an inner wall of the at-least-one-stage diameter-decreased conical part or at least one flow disturbing rib extending longitudinally along an inner wall of the at-least-one-stage diameter-decreased conical part. These flow disturbing parts can help the water flow mix with the sucked air more effectively downstream by increasing the turbulence of the water.

Preferably, the bubbler includes a hole mesh and a hole mesh skeleton, and the hole mesh is attached to the outlet end of the one-piece spray pipe through the hole mesh skeleton. The hole mesh skeleton is provided with at least one overflow hole, and the at least one overflow hole is positioned close to the hole mesh. The overflow hole can prevent excess water from flooding the air inflow hole, thereby preventing a situation in which the micro-bubble water cannot be produced since the air cannot be sucked into the one-piece spray pipe due to blockage of the air inflow hole.

In order to solve the above technical problem, in a second embodiment, the present disclosure provides a micro-bubble spray head, which includes a one-piece spray pipe and a bubbler; the one-piece spray pipe includes a passage formed therein; the passage is provided therein with at-least-one-stage diameter-decreased conical part in a water flow direction, and a smallest-diameter opening is formed at a top of the at-least-one-stage diameter-decreased conical part; the one-piece spray pipe is also formed with an air passage, and the air passage is positioned close to the smallest-diameter opening so that a negative pressure is formed near an outlet of the air passage when a water flow passes through the smallest-diameter opening, and the negative pressure therefore sucks outside air into the one-piece spray pipe to mix with water and produce bubble water; and the bubbler is fixed to an outlet end of the one-piece spray pipe and has a hole mesh structure which is configured to be capable of forming micro-bubble water when the bubble water flows through the bubbler.

In a preferred technical solution of the above micro-bubble spray head, the at-least-one-stage diameter-decreased conical part is positioned close to the outlet end, and the air passage is an air inflow hole formed on a pipe wall of the one-piece spray pipe, or is provided by an off-center part of the bubbler.

In a preferred technical solution of the above micro-bubble spray head, the bubbler extends radially beyond an outer diameter of the outlet end to increase the air sucked through the air passage.

In a preferred technical solution of the above micro-bubble spray head, the at-least-one-stage diameter-decreased conical part is positioned close to an inlet end of the one-piece spray pipe, and the air passage is an air inflow hole formed on the pipe wall of the one-piece spray pipe.

In a preferred technical solution of the above micro-bubble spray head, the air passage is located downstream of the smallest-diameter opening.

In a preferred technical solution of the above micro-bubble spray head, an annular gap is formed between the at-least-one-stage diameter-decreased conical part and an inner wall of the one-piece spray pipe.

In a preferred technical solution of the above micro-bubble spray head, the at-least-one-stage diameter-decreased conical part is a hollow conical varying diameter member which is independent from the one-piece spray pipe, the hollow conical varying diameter member is inserted into the one-piece spray pipe from the inlet end, a largest-diameter end of the hollow conical varying diameter member is flush with and abuts against the inlet end, and the smallest-diameter opening is formed on a smallest-diameter end of the hollow conical varying diameter member.

In a preferred technical solution of the above micro-bubble spray head, the hole mesh structure includes plastic fence, metal mesh, or macromolecular material mesh.

In a preferred technical solution of the above micro-bubble spray head, a hole diameter of the hole mesh structure is in a range from 0 to 1000 microns.

It can be understood by those skilled in the art that in the technical solution of the present disclosure, the micro-bubble spray head includes a one-piece spray pipe and a bubbler installed at the outlet end of the one-piece spray pipe. At-least-one-stage diameter-decreased conical part is provided in a passage of the one-piece spray pipe in a water flow direction, and a smallest-diameter opening is formed at a top of the at-least-one-stage diameter-decreased conical part. The one-piece spray pipe is also formed with an air passage, and the air passage is positioned close to the smallest-diameter opening so that a negative pressure is formed near an outlet of the air passage when a water flow passes through the smallest-diameter opening, and the negative pressure therefore sucks outside air into the one-piece spray pipe to mix with water to produce bubble water. The bubble water is cut and mixed by the bubbler to produce micro-bubble water when it flows through the bubbler. The water flow is accelerated in the at-least-one-stage diameter-decreased conical part. The accelerated water flow is sprayed in an expanded state from the smallest-diameter opening into a downstream cavity in the one-piece spray pipe to generate a negative pressure in the downstream cavity. Under the action of negative pressure, a large amount of air is sucked into the one-piece spray pipe from the outside through the air passage and mixes with water to produce bubble water containing a large number of bubbles. The bubble water then flows through the bubbler located at the outlet end to produce micro-bubble water containing a large number of micro-bubbles. In the technical solution of the micro-bubble spray head of the present disclosure, the function of generating micro-bubbles is realized by the at-least-one-stage diameter-decreased conical part designed in the one-piece spray pipe and the bubbler fixed at the outlet end of the one-piece spray pipe. Therefore, as compared with the micro-bubble generators having many components in the prior art, the micro-bubble spray head of the present disclosure not only has good performance of micro-bubble generation, but also has the number of components thereof greatly reduced, thus also eliminating the need for designing and manufacturing connection structures between the components and significantly reducing the manufacturing cost of the entire micro-bubble spray head.

Preferably, the at-least-one-stage diameter-decreased conical part is positioned close to the outlet end of the one-piece spray pipe, and the air passage is arranged at the outlet end, so that the outlet of the air passage is close to the smallest-diameter opening, thereby facilitating the negative pressure created by the water flow flowing through the at-least-one-stage diameter-decreased conical part to suck the outside air from the air passage. The air passage may not be designed separately, but the off-center part of the hole mesh structure of the bubbler may be used as the air passage. Air is sucked directly into the one-piece spray pipe from the outlet end of the one-piece spray pipe through the bubbler. The radial diameter of the hole mesh structure of the bubbler can be larger than the outer diameter of the outlet end of the one-piece spray pipe, so as to avoid a situation in which the micro-bubble water flowing out of the bubbler blocks most or even all of the mesh holes, thereby allowing more air to be sucked through the bubbler. Alternatively, the air passage may also be an air inflow hole formed on the pipe wall of the one-piece spray pipe at the outlet end.

Preferably, the at-least-one-stage diameter-decreased conical part is positioned close to the inlet end of the one-piece spray pipe, and the air passage is also arranged close to the inlet end, so that the outlet of the air passage is close to the smallest-diameter opening, thereby facilitating the negative pressure created by the water flow flowing through the at-least-one-stage diameter-decreased conical part to suck the outside air from the air passage. The air passage may be an air inflow hole formed on the pipe wall of the one-piece spray pipe near the inlet end.

In order to solve the above technical problem, in a third embodiment, the present disclosure provides a micro-bubble spray head, which includes a one-piece spray pipe and a bubbler; the one-piece spray pipe includes a passage formed therein; the passage is provided therein with a throttling hole in a water flow direction; the one-piece spray pipe is also formed with an air passage, and the air passage is positioned downstream of the throttling hole in the water flow direction so that a negative pressure is formed near an outlet of the air passage when a water flow passes through the throttling hole, and the negative pressure therefore sucks outside air into the one-piece spray pipe to mix with water and produce bubble water; and the bubbler is fixed to the outlet end of the one-piece spray pipe and has a hole mesh structure which is configured to be capable of forming micro-bubble water when the bubble water flows through the bubbler.

In a preferred technical solution of the above micro-bubble spray head, the throttling hole is positioned close to the outlet end, and the air passage is an air inflow hole formed on a pipe wall of the one-piece spray pipe, or is provided by an off-center part of the bubbler.

In a preferred technical solution of the above micro-bubble spray head, the bubbler extends radially beyond an outer diameter of the outlet end to increase the air sucked through the bubbler.

In a preferred technical solution of the above micro-bubble spray head, the throttling hole is positioned close to the inlet end, and the air passage is an air inflow hole formed on a pipe wall of the one-piece spray pipe and is close to the throttling hole.

In a preferred technical solution of the above micro-bubble spray head, the throttling hole is arranged on a radial throttling part extending inward from an inner wall of the one-piece spray pipe.

In a preferred technical solution of the above micro-bubble spray head, the micro-bubble spray head further includes a throttling plate, and an inner wall of the one-piece spray pipe is formed with annular step; the throttling plate is embedded in the one-piece spray pipe in a manner of facing the outlet end and abutting against the annular step, and the throttling hole is formed on the throttling plate.

In a preferred technical solution of the above micro-bubble spray head, the hole mesh structure includes plastic fence, metal mesh, or macromolecular material mesh.

In a preferred technical solution of the above micro-bubble spray head, a hole diameter of the hole mesh structure is in a range from 0 to 1000 microns.

In a preferred technical solution of the above micro-bubble spray head, an outer wall of the outlet end of the one-piece spray pipe has a connection part, and the connection part is used for fixedly connecting the bubbler.

It can be understood by those skilled in the art that in the technical solution of the present disclosure, the micro-bubble spray head includes a one-piece spray pipe and a bubbler installed at the outlet end of the one-piece spray pipe. A throttling hole is provided in a passage of the one-piece spray pipe in a water flow direction. The one-piece spray pipe is also formed with an air passage positioned downstream of the throttling hole, and an outlet of the air passage is close to the throttling hole so that when the water flow passes through the throttling hole, a negative pressure is formed near the outlet of the air passage and thus the outside air is sucked into the one-piece spray pipe by the negative pressure to mix with the water to produce bubble water. The bubble water is cut and mixed by the bubbler to produce micro-bubble water when it flows through the bubbler. The throttling hole causes depressurization and expansion of the water flow. Therefore, when the expanded water flow is sprayed into a downstream cavity of the one-piece spray pipe, a negative pressure can be generated in the downstream cavity. Under the action of negative pressure, a large amount of air is sucked into the one-piece spray pipe from the outside through the air passage and mixes with water to produce bubble water containing a large number of bubbles. The bubble water then flows through the bubbler located at the outlet end to produce micro-bubble water containing a large number of micro-bubbles. In the technical solution of the micro-bubble spray head of the present disclosure, the function of generating micro-bubbles is realized by the throttling hole designed in the one-piece spray pipe and the bubbler fixed at the outlet end of the one-piece spray pipe. Therefore, as compared with the micro-bubble generators having many components in the prior art, the micro-bubble spray head of the present disclosure not only has good performance of micro-bubble generation, but also has the number of components thereof greatly reduced, thus also eliminating the need for designing and manufacturing connection structures between the components, so that the structure of the micro-bubble spray head is also greatly simplified. Correspondingly, the manufacturing cost of the entire micro-bubble spray head is significantly reduced.

Preferably, the throttling hole is positioned close to the outlet end of the one-piece spray pipe, and the air passage is arranged at the outlet end, so that the outlet of the air passage is close to the throttling hole, thereby facilitating the negative pressure created by the water flow flowing through the throttling hole to suck the outside air from the air passage. The air passage may not be designed separately, but is provided by the off-center part of the hole mesh structure of the bubbler. Air is sucked directly into the one-piece spray pipe from the outlet end of the one-piece spray pipe through the bubbler. The radial diameter of the hole mesh structure of the bubbler can be larger than the outer diameter of the outlet end of the one-piece spray pipe, so as to avoid a situation in which the micro-bubble water flowing out of the bubbler blocks most or even all of the mesh holes, thereby allowing more air to be sucked through the bubbler. Alternatively, the air passage may also be an air inflow hole formed on the pipe wall of the one-piece spray pipe at the outlet end.

Preferably, the throttling hole is positioned close to the inlet end of the one-piece spray pipe, and the air passage is also arranged close to the inlet end, so that the outlet of the air passage is close to the throttling hole, thereby facilitating the negative pressure created by the water flow flowing through the throttling hole to suck the outside air from the air passage. The air passage may be an air inflow hole formed on the pipe wall of the one-piece spray pipe near the inlet end.

In order to solve the above technical problem, in a fourth embodiment, the present disclosure provides a micro-bubble spray head, which includes a one-piece spray pipe and a bubbler; the one-piece spray pipe includes a passage formed therein; at-least-one-stage diameter-decreased conical part and at least one stage of diameter-increased conical part are arranged in sequence in the passage in a water flow direction; a first smallest-diameter opening is formed at a smallest-diameter position of the at-least-one-stage diameter-decreased conical part, a second smallest-diameter opening is formed at a smallest-diameter position of the at least one stage of diameter-increased conical part, the at least one stage of diameter-increased conical part is positioned downstream of the first smallest-diameter opening, and the first smallest-diameter opening communicates with the second smallest-diameter opening; the one-piece spray pipe is also formed with an air passage, and the air passage is positioned close to the first smallest-diameter opening so that a negative pressure is formed near an outlet of the air passage when a water flow passes through the first smallest-diameter opening, and the negative pressure therefore sucks outside air into the one-piece spray pipe to mix with water and produce bubble water; and the bubbler is fixed to an outlet end of the one-piece spray pipe and has a hole mesh structure which is configured to be capable of forming micro-bubble water when the bubble water flows through the bubbler.

In a preferred technical solution of the above micro-bubble spray head, the at-least-one-stage diameter-decreased conical part and the at least one stage of diameter-increased conical part are positioned close to the outlet end, and the air passage is formed in an off-center part of the bubbler.

In a preferred technical solution of the above micro-bubble spray head, the bubbler extends radially beyond an outer diameter of the outlet end to increase the air sucked through the bubbler.

In a preferred technical solution of the above micro-bubble spray head, the at-least-one-stage diameter-decreased conical part and the at least one stage of diameter-increased conical part are positioned close to an inlet end of the one-piece spray pipe, and the air passage is an air inflow hole formed on a pipe wall of the one-piece spray pipe.

In a preferred technical solution of the above micro-bubble spray head, the at-least-one-stage diameter-decreased conical part and the at least one stage of diameter-increased conical part are in direct communication, the first smallest-diameter opening and the second smallest-diameter opening coincide with each other, and the air inflow hole is closely adjacent to a largest-diameter opening of the at least one stage of diameter-increased conical part.

In a preferred technical solution of the above micro-bubble spray head, the at-least-one-stage diameter-decreased conical part and the at least one stage of diameter-increased conical part communicate through a throttling hole, the throttling hole extends from the first smallest-diameter opening to the second smallest-diameter opening and has the same diameter as the first smallest-diameter opening and the second smallest-diameter opening, and the air inflow hole is closely adjacent to a largest-diameter opening of the at least one stage of diameter-increased conical part.

In a preferred technical solution of the above micro-bubble spray head, the at-least-one-stage diameter-decreased conical part is configured as a hollow conical varying diameter member which is independent from the one-piece spray pipe, the hollow conical varying diameter member is inserted into the one-piece spray pipe from the inlet end, a largest-diameter end of the hollow conical varying diameter member is flush with the inlet end and abuts against an inner wall of the inlet end, the first smallest-diameter opening is formed on a smallest-diameter end of the hollow conical varying diameter member and is spaced apart from the second smallest-diameter opening by a predetermined distance, and the air inflow hole is located between the first smallest-diameter opening and the second smallest-diameter opening in the water flow direction.

In a preferred technical solution of the above micro-bubble spray head, an annular gap is formed between the hollow conical varying diameter member and an inner wall of the one-piece spray pipe.

In a preferred technical solution of the above micro-bubble spray head, the hole mesh structure includes plastic fence, metal mesh, or macromolecular material mesh.

It can be understood by those skilled in the art that in the technical solution of the present disclosure, the micro-bubble spray head includes a one-piece spray pipe and a bubbler installed at the outlet end of the one-piece spray pipe. A passage of the one-piece spray pipe is sequentially provided therein with at-least-one-stage diameter-decreased conical part and at least one stage of diameter-increased conical part in a water flow direction; a first smallest-diameter opening is formed at a smallest-diameter position of the at-least-one-stage diameter-decreased conical part, a second smallest-diameter opening is formed at a smallest-diameter position of the at least one stage of diameter-increased conical part, the at least one stage of diameter-increased conical part is positioned downstream of the first smallest-diameter opening, and the first smallest-diameter opening communicates with the second smallest-diameter opening. The one-piece spray pipe is also formed with an air passage, and the air passage is positioned close to the first smallest-diameter opening. The water flow is accelerated in the at-least-one-stage diameter-decreased conical part due to the gradual narrowing of its circulation passage; the accelerated water flow is sprayed in an expanded state from the first smallest-diameter opening into a downstream passage in the one-piece spray pipe, and therefore generates a negative pressure near the outlet of the air passage. Under the action of negative pressure, a large amount of air is sucked into the one-piece spray pipe from the outside through the air passage and mixes with water in the one-piece spray pipe to produce bubble water containing a large number of bubbles, and the at least one stage of diameter-increased conical part located downstream of the first smallest-diameter opening helps to increase mixing of air and water. The bubble water then flows through the bubbler located at the outlet end and is cut and mixed by the bubbler, thereby producing micro-bubble water containing a large number of micro-bubbles. In the technical solution of the micro-bubble spray head of the present disclosure, the function of generating micro-bubbles is realized by the at-least-one-stage diameter-decreased conical part and the at least one stage of diameter-increased conical part designed in the one-piece spray pipe, and the bubbler fixed at the outlet end of the one-piece spray pipe. Therefore, as compared with the micro-bubble generators having many components in the prior art, the micro-bubble spray head of the present disclosure not only has good performance of micro-bubble generation, but also has the number of components thereof greatly reduced, thus also eliminating the need for designing and manufacturing connection structures between the components and significantly reducing the manufacturing cost of the entire micro-bubble spray head.

Preferably, the at-least-one-stage diameter-decreased conical part and the at least one stage of diameter-increased conical part are positioned close to the outlet end of the one-piece spray pipe, and the air passage is arranged at the outlet end, so that the outlet of the air passage is close to the first smallest-diameter opening, thereby facilitating the negative pressure created by the water flow flowing through the at-least-one-stage diameter-decreased conical part to suck the outside air from the air passage. The air passage may not be designed separately, but is provided by the off-center part of the hole mesh structure of the bubbler. Air is sucked directly into the one-piece spray pipe from the outlet end of the one-piece spray pipe through the bubbler. More preferably, the radial diameter of the hole mesh structure of the bubbler can be larger than the outer diameter of the outlet end of the one-piece spray pipe, so as to increase an area of the hole mesh structure of the bubbler, thus avoiding a situation in which the micro-bubble water flowing out of the bubbler blocks most or even all of the mesh holes, thereby allowing more air to be sucked through the bubbler. Alternatively, the air passage may also be an air inflow hole formed on the pipe wall of the one-piece spray pipe near the outlet end.

Preferably, the at-least-one-stage diameter-decreased conical part and the at least one stage of diameter-increased conical part are positioned close to the inlet end of the one-piece spray pipe, and the air passage is an air inflow hole formed on the pipe wall of the one-piece spray pipe. The air inflow hole is arranged close to the inlet end and located between the first smallest-diameter opening and the second smallest-diameter opening or closely adjacent to the largest diameter position of the at least one stage of diameter-increased conical part, so as to facilitate the negative pressure created by the water flow flowing through the at-least-one-stage diameter-decreased conical part to suck the outside air from the air inflow hole; then the mixing of air and water is increased by the at least one stage of diameter-increased conical part.

In order to solve the above technical problem, in a fifth embodiment, the present disclosure provides a micro-bubble spray head, which includes a one-piece spray pipe and a bubbler; at-least-one-stage diameter-decreased conical part is arranged in the one-piece spray pipe in a water flow direction; a main spray hole is formed at a top end of the diameter-decreased conical part of a most downstream stage of the at-least-one-stage diameter-decreased conical part, and a plurality of auxiliary spray holes are arranged around the main spray hole on the diameter-decreased conical part of the most downstream stage; at least one air inflow hole is arranged on a pipe wall of the one-piece spray pipe, and the at least one air inflow hole is positioned close to the main spray hole and the auxiliary spray holes so that air is sucked into the one-piece spray pipe through the at least one air inflow hole under the negative pressure caused by expanded spraying of water flow from the main spray hole and the auxiliary spray holes and mixes with the water flow to produce bubble water; and the bubbler is fixed to an outlet end of the one-piece spray pipe and is configured to be capable of forming micro-bubble water when the bubble water flows through the bubbler.

In a preferred technical solution of the above micro-bubble spray head, the main spray hole has a larger diameter than the auxiliary spray holes.

In a preferred technical solution of the above micro-bubble spray head, the diameter of the main spray hole is in a range from 0 to 6 mm.

In a preferred technical solution of the above micro-bubble spray head, the diameter of the auxiliary spray holes is in a range from 0 to 1.2 mm.

In a preferred technical solution of the above micro-bubble spray head, a flow disturbing part is provided on an inner wall of the at-least-one-stage diameter-decreased conical part.

In a preferred technical solution of the above micro-bubble spray head, the flow disturbing part is at least one radial protrusion arranged on the inner wall of the at-least-one-stage diameter-decreased conical part or at least one flow disturbing rib extending longitudinally along the inner wall of the at-least-one-stage diameter-decreased conical part.

In a preferred technical solution of the above micro-bubble spray head, the bubbler includes a hole mesh and a hole mesh skeleton, and the hole mesh is attached to the outlet end of the one-piece spray pipe through the hole mesh skeleton.

In a preferred technical solution of the above micro-bubble spray head, the hole mesh skeleton is provided with at least one overflow hole, and the at least one overflow hole is positioned close to the hole mesh.

In a preferred technical solution of the above micro-bubble spray head, the hole mesh has at least one fine hole having a diameter reaching a micron scale.

In a preferred technical solution of the above micro-bubble spray head, the bubbler further includes a pressure ring, and the pressure ring is configured to be positioned between the hole mesh skeleton and the outlet end of the one-piece spray pipe to fix the hole mesh.

It can be understood by those skilled in the art that in the technical solution of the present disclosure, the micro-bubble spray head includes a one-piece spray pipe and a bubbler installed at an outlet end of the one-piece spray pipe. At-least-one-stage diameter-decreased conical part is provided in the one-piece spray pipe in a water flow direction; a main spray hole is formed at a top end of the diameter-decreased conical part of a most downstream stage of the at-least-one-stage diameter-decreased conical part, and a plurality of auxiliary spray holes are arranged around the main spray hole on the diameter-decreased conical part of the most downstream stage. The water flow is expanded and sprayed into a downstream passage in the one-piece spray pipe from the main spray hole and the auxiliary spray holes and generate a negative pressure in the downstream passage. At least one air inflow hole is provided on the pipe wall of the one-piece spray pipe. Under the action of negative pressure, a large amount of air is sucked into the one-piece spray pipe from the outside through these air inflow holes and mixes with water to produce bubble water containing a large number of bubbles. The bubble water then flows through the bubbler located at the outlet end of the one-piece spray pipe to be cut and mixed by the bubbler, thereby producing micro-bubble water containing a large number of micro-bubbles. On one hand, the water flow sprayed from the main spray hole is very strong, and it is possible that after the water flow is sprayed onto the hole mesh of the bubbler, impurities will accumulate on the spray hole mesh in the circumferential direction around the main spray point, resulting in blockage of a periphery area of the hole mesh to cause failure. The auxiliary spray holes can effectively impact the peripheral part of the hole mesh to provide a self-cleaning function, so as to avoid a phenomenon that the peripheral part of the hole mesh is blocked and fails. On the other hand, the water flow sprayed from the main spray hole and the water flow sprayed from the auxiliary spray holes together generate multiple streams of water flows to jointly suck in the outside air and mix with it. As compared with one stream of water flow, the air sucking and mixing effect is better; when the multiple streams of water flows hit the hole mesh, there will be more turbulent mixing of water flows, which greatly enhances the effect of micro-bubble generation. As compared with the micro-bubble generators having many components in the prior art, the micro-bubble spray head of the present disclosure not only has good performance of micro-bubble generation, but also has the number of components thereof greatly reduced, thus also eliminating the need for designing and manufacturing connection structures between the components and significantly reducing the manufacturing cost of the entire micro-bubble spray head.

Preferably, the main spray hole has a larger diameter than the auxiliary spray holes. Specifically, the diameter of the main spray hole is in a range from 0 to 6 mm; more preferably, the diameter of the main spray hole is in a range from 1.2 mm to 3.5 mm. The diameter of the auxiliary spray holes is in a range from 0 to 1.2 mm; more preferably, the diameter of the auxiliary spray holes is in a range from 0.5 mm to 1 mm.

Preferably, a flow disturbing part is provided on the inner wall of the at-least-one-stage diameter-decreased conical part. The flow disturbing part can be at least one radial protrusion arranged on an inner wall of the at-least-one-stage diameter-decreased conical part or at least one flow disturbing rib extending longitudinally along an inner wall of the at-least-one-stage diameter-decreased conical part. These flow disturbing parts can help the water flow mix with the sucked air more effectively downstream by increasing the turbulence of the water.

Preferably, the bubbler includes a hole mesh and a hole mesh skeleton, and the hole mesh is attached to the outlet end of the one-piece spray pipe through the hole mesh skeleton. The hole mesh skeleton is provided with at least one overflow hole, and the at least one overflow hole is positioned close to the hole mesh. The overflow hole can prevent excess water from flooding the air inflow hole, thereby preventing a situation in which the micro-bubble water cannot be produced since the air cannot be sucked into the one-piece spray pipe due to blockage of the air inflow hole.

In order to solve the above technical problem, in a sixth embodiment, the present disclosure provides a micro-bubble spray head, which includes: a water inflow pipe component having a water inflow end that allows water to flow in and a first connection end; in which the first connection end has a first engagement part, the first connection end is provided therein with at-least-one-stage diameter-decreased conical part in a water flow direction, and a smallest-diameter opening is formed at a top of the at-least-one-stage diameter-decreased conical part; a water outflow pipe component having a second connection end and a water outflow end; in which the second connection end is provided with a second engagement part; in a state where the water inflow pipe component and the water outflow pipe component are assembled, the first engagement part and the second engagement part engage with each other, a first axial gap is formed between the first engagement part and the second engagement part, and a second radial gap is formed between abutting surfaces of the first connection end and the second connection end; the first axial gap and the second radial gap communicate with each other to form an air inflow passage, and an outlet of the air inflow passage is close to the smallest-diameter opening so that when water flows through the smallest-diameter opening, a negative pressure is formed near the outlet of the air inflow passage, and outside air is therefore sucked into the water outflow pipe component by the negative pressure to mix with the water to produce bubble water; and a bubbler, which is fixed to the water outflow end of the water outflow pipe component and has a hole mesh structure which is configured to be capable of forming micro-bubble water when the bubble water flows through the bubbler.

In a preferred technical solution of the above micro-bubble spray head, the at-least-one-stage diameter-decreased conical part includes a first-stage diameter-decreased conical part and a second-stage diameter-decreased conical part, a smallest diameter of the first-stage diameter-decreased conical part is equal to a largest diameter of the second-stage diameter-decreased conical part, and the smallest-diameter opening is formed at a top of the second-stage diameter-decreased conical part.

In a preferred technical solution of the above micro-bubble spray head, the micro-bubble spray head has an insertion part extending from the top toward an interior of the water outflow pipe component around the smallest-diameter opening.

In a preferred technical solution of the above micro-bubble spray head, the first engagement part is an internal threaded hole wall provided in the first connection end, and the second engagement part is an external threaded cylindrical surface provided on the second connection end; or the first engagement part is an external threaded cylindrical surface provided on the first connection end, and the second engagement part is an internal threaded hole wall provided in the second connection end; and the first axial gap is formed between the internal threaded hole wall and the external threaded cylindrical surface.

In a preferred technical solution of the above micro-bubble spray head, the first engagement part is a smooth hole wall provided in the first connection end, the second engagement part is a non-smooth cylindrical surface provided on the second connection end, a plurality of ridges or grooves are provided on the non-smooth cylindrical surface, and the first axial gap is formed between the smooth hole wall and the non-smooth cylindrical surface.

In a preferred technical solution of the above micro-bubble spray head, the first engagement part is a non-smooth hole wall provided in the first connection end, a plurality of ridges or grooves are provided on the non-smooth hole wall, the second engagement part is a smooth cylindrical surface provided on the second connection end, and the first axial gap is formed between the non-smooth hole wall and the smooth cylindrical surface.

In a preferred technical solution of the above micro-bubble spray head, the first engagement part is a non-smooth hole wall provided in the first connection end, and a plurality of ridges and/or grooves are provided on the non-smooth hole wall; the second engagement part is a non-smooth cylindrical surface provided on the second connection end, and a plurality of ridges and/or grooves are provided on the non-smooth cylindrical surface; and the first axial gap is formed between the non-smooth hole wall and the non-smooth cylindrical surface.

In a preferred technical solution of the above micro-bubble spray head, the hole mesh structure includes plastic fence, metal mesh, or macromolecular material mesh.

In a preferred technical solution of the above micro-bubble spray head, a hole diameter of the hole mesh structure is in a range from 0 to 1000 microns.

It can be understood by those skilled in the art that in the technical solution of the present disclosure, the micro-bubble spray head includes a water inflow pipe component provided therein with at-least-one-stage diameter-decreased conical part, and a water outflow pipe component provided with a bubbler at a water outflow end. A smallest-diameter opening is formed at a top of the at-least-one-stage diameter-decreased conical part so that the water inflow pipe component and the water outflow pipe component are in communication, and the air inflow passage is composed of a first axial gap and a second radial gap communicating with each other. The first axial gap is formed between the first engagement part at a first connection end of the water inflow pipe component and the second engagement part at a second connection end of the water outflow pipe component, and the second radial gap is formed between abutting surfaces of the first connection end and the second connection end. Water flows into the water inflow pipe component from a water inflow end of the water inflow pipe component; the water flow is accelerated in the at-least-one-stage diameter-decreased conical part; the accelerated water flow is expanded and sprayed into the water outflow pipe component from the smallest-diameter opening and generates a negative pressure inside the second connection end. Under the action of negative pressure, a large amount of air is sucked into the water outflow pipe component from the outside through the first axial gap and the second radial gap and mixes with water to produce bubble water containing a large number of bubbles; finally, the bubble water flows through the bubbler located at the water outflow end of the water outflow pipe component to produce micro-bubble water containing a large number of micro-bubbles. In the technical solution of the present disclosure, it is only required to combine the first connection end of the water inflow pipe component and the second connection end of the water outflow pipe component together so that the micro-bubble spray head can be formed. Therefore, the micro-bubble spray head can be regarded as a two-piece type micro-bubble spray head. Further, the air inflow passage is combined between the engagement parts of the water inflow pipe component and the water outflow pipe component, so there is no need to separately provide the air inflow passage in other parts of the micro-bubble spray head. As compared with the prior art, the micro-bubble spray head of the present disclosure not only has good performance of micro-bubble generation, but also its components and structure are both greatly simplified, and therefore its manufacturing cost is also significantly reduced.

Preferably, the first engagement part of the first connection end of the water inflow pipe component is an internal threaded hole wall, and the second engagement part of the second connection end of the water outflow pipe component is an external threaded cylindrical surface that meshes with the internal threaded hole wall; or the first engagement part of the first connection end is an external threaded cylindrical surface, and the second engagement part of the second connection end is an internal threaded hole wall that meshes with the external threaded cylindrical surface. In this way, the first axial gap is formed by a gap reserved between the meshing threads, and it constitutes a part of the air inflow passage. Alternatively, the first engagement part is a smooth hole wall, and the second engagement part is a non-smooth cylindrical surface matching with the smooth hole wall and provided with a plurality of ridges or grooves; or the first engagement part is a non-smooth hole wall provided with a plurality of ridges or grooves, and the second engagement part is a smooth cylindrical surface matching with the non-smooth hole wall; or the first engagement part is a non-smooth hole wall provided with a plurality of ridges or grooves, and the second engagement part is a non-smooth cylindrical surface matching with the smooth hole wall and provided with a plurality of ridges or grooves. The matching structure between the engagement parts is not limited to the above structures, and can be any matching structure among “ridge+groove”, “ridge+ridge” and “groove+groove”, as long as these matching engagement structures can achieve the purpose of forming the first axial gap between the first engagement part and the second engagement part.

In order to solve the above technical problem, in a seventh embodiment, the present disclosure provides a micro-bubble spray head, which includes: a water inflow pipe component having a water inflow end that allows water to flow in and a throttling end, the throttling end being provided with a first engagement part; a throttling hole, which is arranged in the water inflow pipe component in a water flow direction; a water outflow pipe component, which has an air mixing end and a micro-bubble generating end, the air mixing end being provided with a second engagement part; in a state where the water inflow pipe component and the water outflow pipe component are assembled, the first engagement part and the second engagement part engage with each other, and an axial gap is formed between the first engagement part and the second engagement part; the axial gap communicates with a radial passage provided on or near the air mixing end to form an air inflow passage; and an outlet of the air inflow passage is located close to the throttling hole so that when water flows through the throttling hole, a negative pressure is formed near the outlet of the air inflow passage, and outside air is therefore sucked into the water outflow pipe component by the negative pressure to mix with the water and produce bubble water; and a bubbler, which is fixed to the micro-bubble generating end of the water outflow pipe component and which is configured to be capable of forming micro-bubble water when the bubble water flows through the bubbler.

In a preferred technical solution of the above micro-bubble spray head, the micro-bubble spray head includes a radial throttling part formed in the throttling end, and the throttling hole is formed on the radial throttling part.

In a preferred technical solution of the above micro-bubble spray head, the micro-bubble spray head includes a throttling plate, an annular rib extending radially inward is provided in the throttling end, the throttling plate abuts against the annular rib toward the water outflow pipe component, and the throttling hole is formed on the throttling plate.

In a preferred technical solution of the above micro-bubble spray head, the radial passage is a radial gap formed between abutting surfaces of the throttling end and the air mixing end, or a radial hole formed directly on the air mixing end.

In a preferred technical solution of the above micro-bubble spray head, the first engagement part is an internal threaded hole wall provided in the throttling end, and the second engagement part is an external threaded cylindrical surface provided on the air mixing end; or the first engagement part is an external threaded cylindrical surface provided on the throttling end, and the second engagement part is an internal threaded hole wall provided in the air mixing end; and the axial gap is formed between the internal threaded hole wall and the external threaded cylindrical surface.

In a preferred technical solution of the above micro-bubble spray head, the first engagement part is a smooth hole wall provided in the throttling end, the second engagement part is a non-smooth cylindrical surface provided on the air mixing end, a plurality of ridges or grooves are provided on the non-smooth cylindrical surface, and the axial gap is formed between the smooth hole wall and the non-smooth cylindrical surface.

In a preferred technical solution of the above micro-bubble spray head, the first engagement part is a non-smooth hole wall provided in the throttling end, a plurality of ridges or grooves are provided on the non-smooth hole wall, the second engagement part is a smooth cylindrical surface provided on the air mixing end, and the axial gap is formed between the non-smooth hole wall and the smooth cylindrical surface.

In a preferred technical solution of the above micro-bubble spray head, the first engagement part is a non-smooth hole wall provided in the throttling end, and a plurality of ridges and/or grooves are provided on the non-smooth hole wall; the second engagement part is a non-smooth cylindrical surface provided on the air mixing end, and a plurality of ridges and/or grooves are provided on the non-smooth cylindrical surface; and the axial gap is formed between the non-smooth hole wall and the non-smooth cylindrical surface.

In a preferred technical solution of the above micro-bubble spray head, the bubbler is a hole mesh structure, and the hole mesh structure includes plastic fence, metal mesh, or macromolecular material mesh.

It can be understood by those skilled in the art that in the technical solution of the present disclosure, the micro-bubble spray head includes a water inflow pipe component provided therein with a throttling hole, and a water outflow pipe component provided with a bubbler at a water outflow end, and the air inflow passage is composed of an axial gap and a radial passage communicating with each other. The axial gap is formed between the first engagement part at a throttling end of the water inflow pipe component and the second engagement part at an air mixing end of the water outflow pipe component, and the radial passage is formed on or near the air mixing end. Water flows into the water inflow pipe component from a water inflow end of the water inflow pipe component; then the water flow is depressurized and expanded by the throttling hole. The expanded water inflow is sprayed into the water outflow pipe component and generates a negative pressure inside the air mixing end. Under the action of negative pressure, a large amount of air is sucked into the air mixing end from the outside through the axial gap and the radial gap and mixes with water to produce bubble water containing a large number of bubbles; finally, the bubble water flows through the bubbler located at a micro-bubble generating end of the water outflow pipe component to produce micro-bubble water containing a large number of micro-bubbles. In the technical solution of the present disclosure, it is only required to combine the throttling end of the water inflow pipe component and the air mixing end of the water outflow pipe component together so that the micro-bubble spray head can be formed. Therefore, the micro-bubble spray head can be regarded as a two-piece type micro-bubble spray head. Further, the air inflow passage is combined between the engagement parts of the water inflow pipe component and the water outflow pipe component, so there is no need to separately provide the air inflow passage in other parts of the micro-bubble spray head. As compared with the prior art, the micro-bubble spray head of the present disclosure not only has good performance of micro-bubble generation, but also its components and structure are both greatly simplified, and therefore its manufacturing cost is also significantly reduced.

Preferably, the first engagement part of the throttling end of the water inflow pipe component is an internal threaded hole wall, and the second engagement part of the air mixing end of the water outflow pipe component is an external threaded cylindrical surface that meshes with the internal threaded hole wall; or the first engagement part of the throttling end is an external threaded cylindrical surface, and the second engagement part of the air mixing end is an internal threaded hole wall that meshes with the external threaded cylindrical surface. In this way, the axial gap is formed by a gap reserved between the meshing threads, and it constitutes a part of the air inflow passage. Alternatively, the first engagement part is a smooth hole wall, and the second engagement part is a non-smooth cylindrical surface matching with the smooth hole wall and provided with a plurality of ridges or grooves; or the first engagement part is a non-smooth hole wall provided with a plurality of ridges or grooves, and the second engagement part is a smooth cylindrical surface matching with the non-smooth hole wall; or the first engagement part is a non-smooth hole wall provided with a plurality of ridges or grooves, and the second engagement part is a non-smooth cylindrical surface matching with the smooth hole wall and provided with a plurality of ridges or grooves. These matching engagement structures can each achieve the purpose of forming the axial gap between the first engagement part and the second engagement part.

The present disclosure also provides a washing apparatus, which includes any of the micro-bubble spray heads as described above, and the micro-bubble spray head is configured to generate micro-bubble water in the washing apparatus. The micro-bubble spray head generates micro-bubble water containing a large number of micro-bubbles in the washing apparatus, so it can not only improve the cleaning ability of the washing apparatus, but also can reduce the amount of detergent used and a residual amount of detergent such as in the clothing.

### BRIEF DESCRIPTION OF DRAWINGS

Preferred embodiments of the present disclosure will be described below with reference to the accompanying drawings, in which:

FIG. 1 is a schematic structural view of an example of a washing apparatus including a micro-bubble spray head according to the present disclosure;

FIG. 2 is a schematic structural view of another example of the washing apparatus including the micro-bubble spray head according to the present disclosure;

FIG. 3 is a schematic perspective view of an example of the micro-bubble spray head in a first embodiment of the present disclosure;

FIG. 4 is a top view of the example of the micro-bubble spray head in the first embodiment of the present disclosure shown in FIG. 3;

FIG. 5 is a front view of the example of the micro-bubble spray head in the first embodiment of the present disclosure shown in FIG. 3;

FIG. 6 is a cross-sectional view of the example of the micro-bubble spray head in the first embodiment of the present disclosure taken along section line A-A in FIG. 5;

FIG. 7 is a schematic perspective view of an example of the micro-bubble spray head in a second embodiment of the present disclosure;

FIG. 8 is a front view of an example of the micro-bubble spray head in the second embodiment of the present disclosure shown in FIG. 7;

FIG. 9 is a top view of an example of the micro-bubble spray head in the second embodiment of the present disclosure shown in FIG. 7;

FIG. 10 is a cross-sectional view of a first example of the micro-bubble spray head in the second embodiment of the present disclosure taken along section line E-E in FIG. 9;

FIG. 11 is a cross-sectional view of a second example of the micro-bubble spray head in the second embodiment of the present disclosure taken along section line E-E in FIG. 9;

FIG. 12 is a cross-sectional view of a third example of the micro-bubble spray head in the second embodiment of the present disclosure taken along section line E-E in FIG. 9;

FIG. 13 is a cross-sectional view of a fourth example of the micro-bubble spray head in the second embodiment of the present disclosure taken along section line E-E in FIG. 9;

FIG. 14 is a cross-sectional view of a fifth example of the micro-bubble spray head in the second embodiment of the present disclosure taken along section line E-E in FIG. 9;

FIG. 15 is a cross-sectional view of a sixth example of the micro-bubble spray head in the second embodiment of the present disclosure taken along section line E-E in FIG. 9;

FIG. 16 is a schematic perspective view of an example of the micro-bubble spray head in a third embodiment of the present disclosure;

FIG. 17 is a front view of an example of the micro-bubble spray head in the third embodiment of the present disclosure shown in FIG. 16;

FIG. 18 is a top view of an example of the micro-bubble spray head in the third embodiment of the present disclosure shown in FIG. 16;

FIG. 19 is a cross-sectional view of a first example of the micro-bubble spray head in the third embodiment of the present disclosure taken along section line E-E in FIG. 18;

FIG. 20 is a cross-sectional view of a second example of the micro-bubble spray head in the third embodiment of the present disclosure taken along section line E-E in FIG. 18;

FIG. 21 is a cross-sectional view of a third example of the micro-bubble spray head in the third embodiment of the present disclosure taken along section line E-E in FIG. 18;

FIG. 22 is a cross-sectional view of a fourth example of the micro-bubble spray head in the third embodiment of the present disclosure taken along section line E-E in FIG. 18;

FIG. 23 is a cross-sectional view of a fifth example of the micro-bubble spray head in the third embodiment of the present disclosure taken along section line E-E in FIG. 18;

FIG. 24 is a schematic perspective view of an example of the micro-bubble spray head in a fourth embodiment of the present disclosure;

FIG. 25 is a front view of an example of the micro-bubble spray head in the fourth embodiment of the present disclosure shown in FIG. 24;

FIG. 26 is a top view of an example of the micro-bubble spray head in the fourth embodiment of the present disclosure shown in FIG. 24;

FIG. 27 is a cross-sectional view of a first example of the micro-bubble spray head in the fourth embodiment of the present disclosure taken along section line E-E in FIG. 26;

FIG. 28 is a cross-sectional view of a second example of the micro-bubble spray head in the fourth embodiment of the present disclosure taken along section line E-E in FIG. 26;

FIG. 29 is a cross-sectional view of a third example of the micro-bubble spray head in the fourth embodiment of the present disclosure taken along section line E-E in FIG. 26;

FIG. 30 is a cross-sectional view of a fourth example of the micro-bubble spray head in the fourth embodiment of the present disclosure taken along section line E-E in FIG. 26;

FIG. 31 is a cross-sectional view of a fifth example of the micro-bubble spray head in the fourth embodiment of the present disclosure taken along section line E-E in FIG. 26;

FIG. 32 is a schematic perspective view of an example of the micro-bubble spray head in a fifth embodiment of the present disclosure;

FIG. 33 is a top view of the example of the micro-bubble spray head in the fifth embodiment of the present disclosure shown in FIG. 32;

FIG. 34 is a front view of the example of the micro-bubble spray head in the fifth embodiment of the present disclosure shown in FIG. 32;

FIG. 35 is a cross-sectional view of the example of the micro-bubble spray head in the fifth embodiment of the present disclosure taken along section line A-A in FIG. 34;

FIG. 36 is a cross-sectional view of the example of the micro-bubble spray head in the fifth embodiment of the present disclosure taken along section line B-B in FIG. 34;

FIG. 37 is a schematic exploded perspective view of the example of the micro-bubble spray head in the fifth embodiment of the present disclosure;

FIG. 38 is a schematic perspective view of an example of the micro-bubble spray head in a sixth embodiment of the present disclosure;

FIG. 39 is a front view of an example of the micro-bubble spray head in the sixth embodiment of the present disclosure shown in FIG. 38;

FIG. 40 is a top view of an example of the micro-bubble spray head in the sixth embodiment of the present disclosure shown in FIG. 38;

FIG. 41 is a cross-sectional view of an example of the micro-bubble spray head in the sixth embodiment of the present disclosure taken along section line E-E in FIG. 40;

FIG. 42 is a cross-sectional view of another example of the micro-bubble spray head in the sixth embodiment of the present disclosure taken along section line E-E in FIG. 40;

FIG. 43 is a schematic perspective view of an example of the micro-bubble spray head in a seventh embodiment of the present disclosure;

FIG. 44 is a front view of an example of the micro-bubble spray head in the seventh embodiment of the present disclosure shown in FIG. 43;

FIG. 45 is a top view of an example of the micro-bubble spray head in the seventh embodiment of the present disclosure shown in FIG. 43;

FIG. 46 is a cross-sectional view of a first example of the micro-bubble spray head in the seventh embodiment of the present disclosure taken along section line E-E of FIG. 45;

FIG. 47 is a cross-sectional view of a second example of the micro-bubble spray head in the seventh embodiment of the present disclosure taken along section line E-E of FIG. 45; and

FIG. 48 is a cross-sectional view of a third example of the micro-bubble spray head in the seventh embodiment of the present disclosure taken along section line E-E of FIG. 45.

### LIST OF REFERENCE SIGNS

1: pulsator washing machine; 11: cabinet; 12: tray; 13: upper cover; 14: foot of pulsator washing machine; 21: outer tub; 31: inner tub; 311: spin-drying hole; 32: pulsator; 33: transmission shaft of pulsator washing machine; 34: motor of pulsator washing machine; 35: balance ring; 41: drain valve; 42: drain pipe; 51: water inflow valve; 9: drum washing machine; 91: shell; 92: outer cylinder; 93: inner cylinder; 931: motor of drum washing machine; 932: transmission shaft of drum washing machine; 933: bearing; 94: top panel; 95: control panel; 96: observation window; 97: door; 98: foot of drum washing machine.

### First Embodiment

52: micro-bubble spray head; 521: one-piece spray pipe; 522: bubbler; 211: inlet end; 212: outlet end; 213: anti-disengagement part; 214A: first fixed installation part; 214B: second fixed installation part; 215: positioning part; 216: air inflow hole; 217: spray hole; 218: flow disturbing part; 219: at-least-one-stage diameter-decreased conical part; 219A: first-stage diameter-decreased conical part; 219B: second-stage diameter-decreased conical part; 221: hole mesh; 222: hole mesh skeleton; 223: overflow hole; 224: connection part of hole mesh; 225: pressure ring; 226: pressure ring hole; 300: annular gap.

### Second Embodiment

52: micro-bubble spray head; 521: one-piece spray pipe; 522: bubbler; 523A: first fixed installation part; 523B: second fixed installation part; 524: positioning part; 525: air passage; 526: sealing ring; 211: inlet end; 212: outlet end; 213: anti-disengagement rib; 214: connection part; 215: cylindrical part; 216: one-stage diameter-decreased conical part; 217: smallest-diameter opening; 218: mixing part; 219: annular gap.

### Third Embodiment

52: micro-bubble spray head; 521: one-piece spray pipe; 522: bubbler; 523A: first fixed installation part; 523B: second fixed installation part; 524: positioning part; 525: air passage; 526: sealing ring; 211: inlet end; 212: outlet end; 213: anti-disengagement rib; 214: connection part; 215: throttling hole; 216: radial throttling part; 216′: throttling plate; 217: first cylindrical part; 218: second cylindrical part.

### Fourth Embodiment

52: micro-bubble spray head; 521: one-piece spray pipe; 522: bubbler; 523A: first fixed installation part; 523B: second fixed installation part; 524: positioning part; 525: air passage; 211: inlet end; 212: outlet end; 213: anti-disengagement rib; 214: connection part; 215: one-stage diameter-decreased conical part; 216: one-stage diameter-increased conical part; 217: first smallest-diameter opening; 218: second smallest-diameter opening; 219: cylindrical part; 300: throttling hole; 301: annular gap.

### Fifth Embodiment

52: micro-bubble spray head; 521: one-piece spray pipe; 522: bubbler; 121: external thread; 211: inlet end; 212: outlet end; 213: anti-disengagement part; 214A: first fixed installation part; 214B: second fixed installation part; 215: positioning part; 216: air inflow hole; 217: main spray hole; 218: flow disturbing part; 219: at-least-one-stage diameter-decreased conical part; 219A: first-stage diameter-decreased conical part; 219B: second-stage diameter-decreased conical part; 220: auxiliary spray hole; 221: hole mesh; 222: hole mesh skeleton; 223: overflow hole; 224: connection part of hole mesh; 225: pressure ring; 226: pressure ring hole; 300: annular gap.

### Sixth Embodiment

52: micro-bubble spray head; 521: water inflow pipe component; 522: water outflow pipe component; 523: bubbler; 524A: first fixed installation part; 524B: second fixed installation part; 525: first axial gap; 526: second radial gap; 211: water inflow end; 212: first connection end; 213: first engagement part; 214: first cylindrical part; 215: second cylindrical part; 216: first-stage diameter-decreased conical part; 217: second-stage diameter-decreased conical part; 218: smallest-diameter opening; 219: insertion part; 221: second connection end; 222: second engagement part; 223: water outflow end.

### Seventh Embodiment

52: micro-bubble spray head; 521: water inflow pipe component; 522: water outflow pipe component; 523: bubbler; 524A: first fixed installation part; 524B: second fixed installation part; 525: throttling hole; 526: axial gap; 527: radial gap; 528: throttling part; 528′: throttling plate; 529: sealing ring; 211: first engagement part; 212: water inflow end; 213: throttling end; 221: second engagement part; 222: micro-bubble generating end; 223: air mixing end; 281: insertion part.

### DETAILED DESCRIPTION

Preferred embodiments of the present disclosure will be described below with reference to the accompanying drawings. It should be understood by those skilled in the art that these embodiments are only used to explain the technical principle of the present disclosure, and are not intended to limit the scope of protection of the present disclosure.

It should be noted that in the description of the present disclosure, terms indicating directional or positional relationships, such as “upper”, “lower”, “left”, “right”, “inner”, “outer” and the like, are based on the directional or positional relationships shown in the accompanying drawings. They are only used for ease of description, and do not indicate or imply that the device or element must have a specific orientation, or be constructed or operated in a specific orientation, and therefore they should not be considered as limitations to the present disclosure. In addition, terms “first” and “second” are only used for descriptive purposes, and should not be interpreted as indicating or implying relative importance.

In addition, it should also be noted that in the description of the present disclosure, unless otherwise clearly specified and defined, terms “install”, “arrange” and “connect” should be understood in a broad sense; for example, the connection may be a fixed connection, or may also be a detachable connection, or an integral connection; it may be a direct connection, or an indirect connection implemented through an intermediate medium, or it may be internal communication between two elements. For those skilled in the art, the specific meaning of the above terms in the present disclosure can be interpreted according to specific situations.

In order to solve the problem that existing micro-bubble generators have a complicated structure and the manufacturing cost is high, the present disclosure provides a micro-bubble spray head 52, which includes: a spray pipe, which is a one-piece or two-piece hollow pipe structure; in which an air inflow passage is provided on the spray pipe, and the spray pipe is configured such that water flow can generate a negative pressure in the spray pipe, and that outside air can be sucked into the spray pipe through the air inflow passage by means of the negative pressure and mix with the water flow in the spray pipe to form bubble water; and a bubbler, which is fixed at an outlet end of the spray pipe and which is configured to be capable of forming micro-bubble water when the bubble water flows through the bubbler. Therefore, as compared with the micro-bubble generators in the prior art, the number of components and the structure of the micro-bubble spray head of the present disclosure are both greatly simplified, and the manufacturing cost of the micro-bubble spray head is also significantly reduced; at the same time, the micro-bubble spray head still maintains a good performance of micro-bubble generation.

The micro-bubble spray head of the present disclosure can be applied in the field of washing, the field of sterilization, or other fields that require micro-bubbles. For example, the micro-bubble spray head of the present disclosure can be applied not only to a washing apparatus, but also to devices such as bathroom faucets or showers.

Therefore, the present disclosure also provides a washing apparatus, which includes the micro-bubble spray head 52 of the present disclosure. The micro-bubble spray head 52 is configured to generate micro-bubble water in the washing apparatus. The micro-bubble water containing a large number of micro-bubbles is generated in the washing apparatus by the micro-bubble spray head. The micro-bubble water can not only improve the washing ability of the washing apparatus, but also can reduce the amount of detergent used and a residual amount of detergent such as in the clothing, which is not only advantageous for the user's health, but also can improve the user experience.

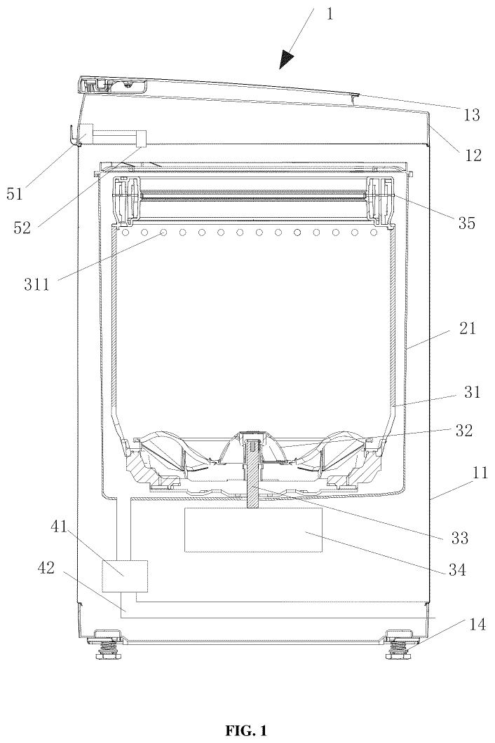

Reference is made to FIG. 1, which is a schematic structural view of an example of a washing apparatus including a micro-bubble spray head according to the present disclosure. In this example, the washing apparatus is a pulsator washing machine 1. Alternatively, in other examples, the washing apparatus may be a drum washing machine or a washing-drying integrated machine, etc.

As shown in FIG. 1, the pulsator washing machine 1 (hereinafter referred to as the washing machine) includes a cabinet 11. Feet 14 are provided at a bottom of the cabinet 11. An upper part of the cabinet 11 is provided with a tray 12, and the tray 12 is pivotally connected with an upper cover 13. An outer tub 21 serving as a water containing tub is provided inside the cabinet 11. An inner tub 31 is arranged in the outer tub 21, a pulsator 32 is arranged at a bottom of the inner tub 31, and a motor 34 is fixed at a lower part of the outer tub 21. The motor 34 is drivingly connected with the pulsator 32 through a transmission shaft 33. A spin-drying hole 311 is provided on a side wall of the inner tub 31 close to a top end. A drain valve 41 is provided on a drain pipe 42, and an upstream end of the drain pipe 42 communicates with a bottom of the outer tub 21. The washing machine further includes a water inflow valve 51 and a micro-bubble spray head 52 communicating with the water inflow valve 51, and the micro-bubble spray head 52 is installed at a top of the outer tub 21. Water enters the micro-bubble spray head 52 through the water inflow valve 51 to generate micro-bubble water containing a large number of micro-bubbles. The micro-bubble spray head 52 sprays the micro-bubble water into a detergent box to mix with a detergent, and then the micro-bubble water enters the inner tub 31 through the detergent box for clothing washing. The micro-bubbles in the water impact the detergent during the breaking up process, and negative charges carried by the micro-bubbles can also adsorb the detergent, so the micro-bubbles can increase a mixing degree of the detergent and the water, thereby reducing the amount of detergent used and a residual amount of detergent in the clothing. In addition, the micro-bubbles in the inner tub 31 will also impact stains on the clothing, and will adsorb foreign matters that generate the stains. Therefore, the micro-bubbles also enhance a stain removal performance of the washing machine. Optionally, the micro-bubble spray head can also directly spray the micro-bubble water carrying a large number of micro-bubbles into the outer tub 21 or the inner tub 31 of the washing machine to further reduce the amount of detergent used and enhance the cleaning ability of the washing machine.

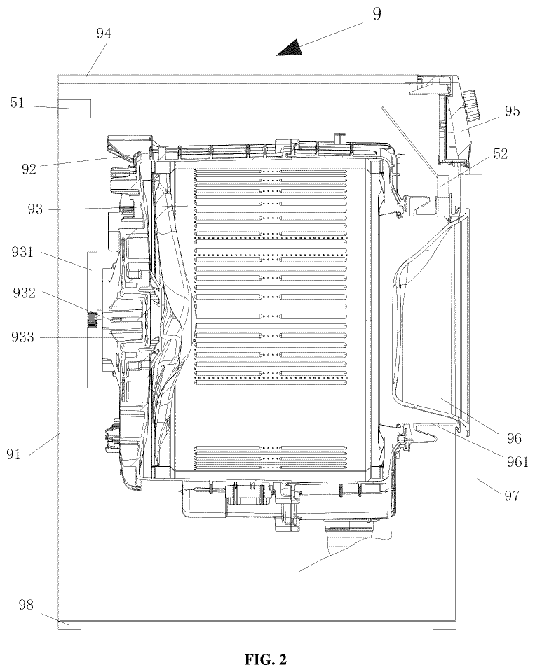

Reference is made to FIG. 2, which is a schematic structural view of another example of the washing apparatus including the micro-bubble spray head according to the present disclosure. In this example, the washing apparatus is a drum washing machine 9.

As shown in FIG. 2, the drum washing machine 9 includes a shell 91 and feet 98 located at a bottom of the shell. A top panel 94 is provided at a top of the shell 91. A front side of the shell 91 (an operation side facing the user) is provided with a door 97 that allows the user to put clothing and the like into the drum washing machine, and the door 97 is also provided with an observation window 96 for viewing an interior of the washing machine. A sealing window gasket 961 is also provided between the observation window 96 and the shell 91, and the sealing window gasket 961 is fixed on the shell 91. A control panel 95 of the drum washing machine 9 is arranged on an upper part of the front side of the shell 91 to facilitate the user's operation. An outer cylinder 92 and an inner cylinder 93 are arranged inside the shell 91. The inner cylinder 93 is positioned inside the outer cylinder 92. The inner cylinder 93 is connected to a motor 931 (e.g., a direct drive motor) through a transmission shaft 932 and a bearing 933. A water inflow valve 51 is provided on an upper part of a rear side of the shell 91, and the water inflow valve 51 is connected to a micro-bubble spray head 52 through a water pipe. As shown in FIG. 2, the micro-bubble spray head 52 is positioned close to the upper part of the front side of the shell 91 and located below the control panel 95. Similar to the above example, water enters the micro-bubble spray head 52 through the water pipe from the water inflow valve 51 to generate micro-bubble water containing a large number of micro-bubbles. The micro-bubble spray head 52 sprays the micro-bubble water into a detergent box to mix with a detergent, and then the micro-bubble water enters the inner cylinder 93 through the detergent box for clothing washing. Optionally, the micro-bubble spray head 52 can also directly spray the micro-bubble water carrying a large number of micro-bubbles into the outer cylinder 92 or the inner cylinder 93 of the washing machine to further reduce the amount of detergent used and enhance the cleaning ability of the washing machine.

### First Embodiment

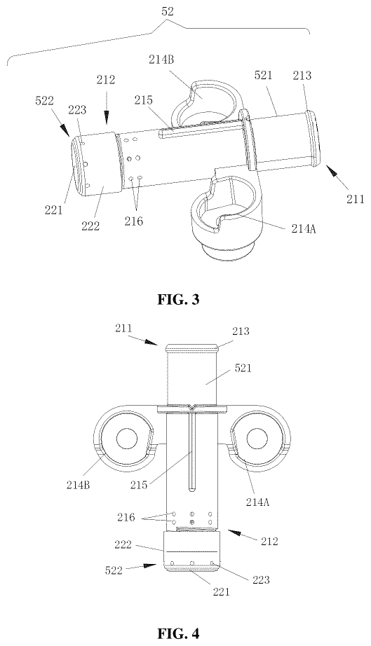

In the first embodiment, the micro-bubble spray head 52 includes an one-piece spray pipe 521 and a bubbler 522 (see FIGS. 3 to 6). At-least-one-stage diameter-decreased conical part 219 is provided in the one-piece spray pipe 521 in a water flow direction C. A spray hole 217 is formed at a top of a downstream end of the at-least-one-stage diameter-decreased conical part 219, and a water flow flowing through the at-least-one-stage diameter-decreased conical part 219 generates a negative pressure in the one-piece spray pipe 521 after the water flow is sprayed from the spray hole in an expanded state. A flow disturbing part 218 is provided on an inner wall of the at-least-one-stage diameter-decreased conical part 219. At least one air inflow hole 216 is provided on a pipe wall of the one-piece spray pipe 521, and the at least one air inflow hole 216 is positioned close to the spray hole 217, so that outside air is sucked into the one-piece spray pipe 521 through the at least one air inflow hole 216 under the action of the negative pressure and mix with the water flow to produce bubble water. The bubbler 522 is fixed to an outlet end 212 of the one-piece spray pipe 521 and is configured to be capable of forming micro-bubble water when the bubble water flows through the bubbler 522. The “diameter-decreased conical part” as used herein refers to a structure in which a diameter of passage formed inside this part is gradually decreased so that the passage has a conical shape.

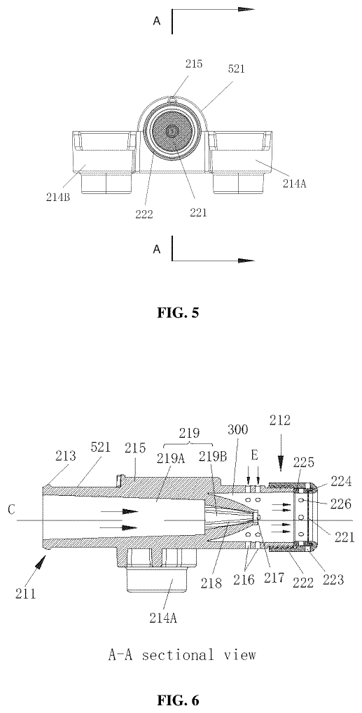

Reference is made to FIGS. 3 to 6, which are schematic views of the example of the micro-bubble spray head in the first embodiment of the present disclosure, in which FIG. 3 is a schematic perspective view of an example of the micro-bubble spray head in the first embodiment of the present disclosure, FIG. 4 is a top view of the example of the micro-bubble spray head in the first embodiment of the present disclosure shown in FIG. 3, FIG. 5 is a front view of the example of the micro-bubble spray head in the first embodiment of the present disclosure shown in FIG. 3, and FIG. 6 is a cross-sectional view of the example of the micro-bubble spray head in the first embodiment of the present disclosure taken along section line A-A in FIG. 5. As shown in FIGS. 3-6, in one or more examples, the micro-bubble spray head 52 of the present disclosure includes a one-piece spray pipe 521. A bubbler 522 is installed on an outlet end 212 of the one-piece spray pipe 521, and the bubbler 522 is configured to be capable of cutting and mixing the bubble water as it flows through the bubbler 522 so as to produce micro-bubble water containing a large number of micro-bubbles.

Referring to FIG. 3, in one or more examples, the one-piece spray pipe 521 has an inlet end 211 and an outlet end 212. The bubbler 522 is fixed on the outlet end 212, and the inlet end 211 is configured to be connected to an external water source. Optionally, an anti-disengagement part 213 may be provided on the inlet end 211, such as an anti-disengagement rib protruding radially outward around an outer wall of the inlet end 211 or an annular groove structure recessed inward from the outer wall of the inlet end 211. The anti-disengagement part can prevent the one-piece spray pipe from falling off a connected pipeline which provides water supply.

With continued reference to FIG. 3, in one or more examples, the outer wall of the one-piece spray pipe 521 is provided with a first fixed installation part 214A, a second fixed installation part 214B, and a positioning part 215, which are used to position and fix the micro-bubble spray head 52 to a predetermined position.

With reference to FIGS. 4 and 5, the first fixed installation part 214A and the second fixed installation part 214B are symmetrically positioned on the outer wall of the one-piece spray pipe 521, and are located in the middle of the one-piece spray pipe 521. The positioning part 215 is a long-strip-shaped rib, which protrudes radially outward from the outer wall of the one-piece spray pipe 521 and extends in a longitudinal direction of the one-piece spray pipe 521. The first fixed installation part 214A and the second fixed installation part 214B are distributed on both sides of the positioning part 215. Optionally, only one fixed installation part is provided on the one-piece spray pipe 521, and the positioning part 215 may also be in other suitable forms.

In one or more examples, the first and second fixed installation parts 214A, 214B are screw hole structures so that the spray head 52 can be fixed to a target position by screws. However, the fixed installation parts may be any suitable connection structure, such as a snap-fit connection structure, a welded connection structure, and the like.

Referring to FIG. 6, a first-stage diameter-decreased conical part 219A and a second-stage diameter-decreased conical part 219B are provided in the one-piece spray pipe 521 in the water flow direction C. A spray hole 217 is formed at a top of a downstream end of the second-stage diameter-decreased conical part 219B. The spray hole 217 communicates inner passages of the first-stage diameter-decreased conical part 219A and the second-stage diameter-decreased conical part 219B with a downstream passage of the one-piece spray pipe 521. In one or more alternative examples, the at-least-one-stage diameter-decreased conical part may be a one-stage diameter-decreased conical part, or may also be more than two stages of multi-stage diameter-decreased conical part. The spray hole 217 is always formed at a top of the diameter-decreased conical part of a most downstream stage in the water flow direction C.

With continued reference to FIG. 6, a flow disturbing part 218 is formed on an inner wall of the second-stage diameter-decreased conical part 219B. In one or more examples, the flow disturbing part 218 is at least one flow disturbing rib extending longitudinally along the inner wall of this stage of diameter-decreased conical part, such as a plurality of flow disturbing ribs. In an alternative example, the flow disturbing part 218 may be at least one radial protrusion on the inner wall of this stage of diameter-decreased conical part, such as one or more cylindrical protrusions. In an alternative example, the flow disturbing part 218 may also be formed on the first-stage diameter-decreased conical part 219A, or each stage of the diameter-decreased conical part may have a flow disturbing part formed thereon.

As shown in FIG. 6, an outer wall of the second-stage diameter-decreased conical part 219B is separate from the inner wall of the one-piece spray pipe, so that an annular gap 300 is formed between the outer wall of the second-stage diameter-decreased conical part 219B and the inner wall of the one-piece spray pipe 521. The annular gap 300 facilitates the mixing of air and water flow, thereby generating more micro-bubbles.

As shown in FIG. 6, the outer wall of the one-piece spray pipe 521 is formed with a plurality of air inflow holes 216 arranged in two rows to form a ring shape. These air inflow holes 216 are all positioned close to the spray hole 217. The water flow enters from the inlet end 211 and first flows through the first-stage diameter-decreased conical part 219A and the second-stage diameter-decreased conical part 219B to accelerate the water flow, whereas the flow disturbing part 218 increases the turbulence of the water flow; the accelerated water flow is expanded and sprayed into the downstream passage of the one-piece spray pipe 521 from the spray hole 217, and generates a negative pressure therein; under the action of the negative pressure, a large amount of outside air is sucked into the one-piece spray pipe 521 from the air inflow holes 216 in a direction E and mix with the water flow in the one-piece spray pipe 521 to produce bubble water. In alternative embodiments, more or fewer air inflow holes may be provided as needed, and they may be arranged in other ways, such as in a staggered arrangement.

With continued reference to FIGS. 3 to 6, the bubbler 522 includes a hole mesh 221 and a hole mesh skeleton 222. The hole mesh 221 is attached to the outlet end 212 of the one-piece spray pipe 521 through the hole mesh skeleton 222.

In one or more examples, the hole mesh 221 has at least one fine hole having a diameter reaching a micron scale. Preferably, the diameter of the fine hole is between 0 and 1000 microns; more preferably, the diameter of the fine hole is between 5 microns and 500 microns. The hole mesh 221 can be a plastic fence, a metal mesh, a macromolecular material mesh, or other suitable hole mesh structures. The plastic fence usually refers to a macromolecular fence, which is integrally injection-molded by using a macromolecular material; or a macromolecular material is first made into a plate, and then a microporous structure is formed on the plate by machining to form the plastic fence. The macromolecular material mesh usually refers to a mesh with a microporous structure made by first making a macromolecular material into wires, and then weaving the wires. The macromolecular material mesh may include nylon mesh, cotton mesh, polyester mesh, polypropylene mesh, and the like. Alternatively, the hole mesh 221 may be other hole mesh structures capable of generating micro-bubbles, such as a hole mesh structure composed of two non-micron-scale honeycomb structures. When the bubble water flows through the hole mesh 221, the hole mesh 221 mixes and cuts the bubble water, thereby generating micro-bubble water.

Referring to FIG. 6, the hole mesh skeleton 222 is cylindrical so that it can be sleeved over the outlet end 212 of the one-piece spray pipe 521. In one or more examples, an inner wall of the hole mesh skeleton 222 is provided with internal threads to mesh with external threads on the outer wall of the outlet end 212. Optionally, a set gap may be reserved between the meshing external threads and internal threads to allow air to be sucked into the one-piece spray pipe through the gap. In alternative examples, the hole mesh skeleton 222 may be connected to the outlet end of the one-piece spray pipe 521 by other connection means, such as welding.

As shown in FIG. 6, in one or more examples, the hole mesh skeleton 222 is provided with a plurality of overflow holes 223 along its periphery, and these overflow holes are positioned close to the hole mesh 221. When the bubble water cannot pass through the hole mesh 221 in time, the excess bubble water can flow out from the overflow holes 223, thereby preventing the excess water from flowing back and flooding the air inflow hole 216. Therefore, the overflow holes 223 can prevent a situation in which the air cannot be sucked into the one-piece spray pipe due to the blockage of the air inflow hole so that the micro-bubble water cannot be generated. In alternative examples, more or fewer overflow holes 223 may be provided as needed.

With further reference to FIG. 6, in one or more examples, a pressure ring 225 is also provided between the hole mesh skeleton 222 and the outlet end 212 of the one-piece spray pipe 521. Correspondingly, a connection part 224 is provided on the periphery of the hole mesh 221. The pressure ring 225 presses the connection part 224 on the inner wall of the end of the hole mesh skeleton 222, so that the hole mesh 221 can be firmly fixed, and that the hole mesh 221 will not fall off the outlet end 212 of the one-piece spray pipe 521 when it is impacted by high-pressure water flow. In one or more examples, the pressure ring 225 is also provided with a plurality of pressure ring holes 226, and these holes communicate with the overflow holes 223 to discharge excess water.

### Second Embodiment

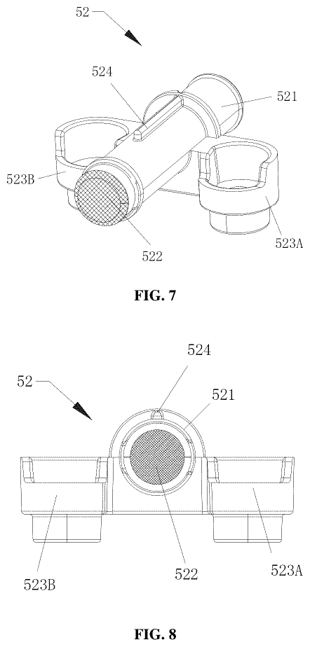

Reference is made to FIGS. 7 to 9, in which FIG. 7 is a schematic perspective view of an example of the micro-bubble spray head in the second embodiment of the present disclosure, FIG. 8 is a front view of an example of the micro-bubble spray head in the second embodiment of the present disclosure shown in FIG. 7, and FIG. 9 is a top view of an example of the micro-bubble spray head in the second embodiment of the present disclosure shown in FIG. 7. As shown in FIGS. 7 to 9, as an example, the micro-bubble spray head 52 of the present disclosure includes a one-piece spray pipe 521. A bubbler 522 is installed at an outlet end of the one-piece spray pipe 521, and the bubbler 522 is a hole mesh structure and is configured to be capable of cutting and mixing the bubble water as it flows through the bubbler 522 so as to produce micro-bubble water containing a large number of micro-bubbles.

Optionally, the hole mesh structure of the bubbler 522 has at least one fine hole having a diameter reaching a micron scale. Preferably, the diameter of the fine hole is between 0 and 1000 microns; more preferably, the diameter of the fine hole is between 5 microns and 500 microns. The hole mesh structure of the bubbler 522 can be a plastic fence, a metal mesh, a macromolecular material mesh, or other suitable hole mesh structures. The plastic fence usually refers to a macromolecular fence, which is integrally injection-molded by using a macromolecular material; or a macromolecular material is first made into a plate, and then a microporous structure is formed on the plate by machining to form the plastic fence. The macromolecular material mesh usually refers to a mesh with a microporous structure made by first making a macromolecular material into wires, and then weaving the wires. The macromolecular material mesh may include nylon mesh, cotton mesh, polyester mesh, polypropylene mesh, and the like. Alternatively, the bubbler 522 may be other hole mesh structures capable of generating micro-bubbles, such as a hole mesh structure composed of two non-micron-scale honeycomb structures.

Optionally, the outer wall of the one-piece spray pipe 521 is provided with a first fixed installation part 523A, a second fixed installation part 523B, and a positioning part 524, which are used to position and fix the micro-bubble spray head 52 to a predetermined position.

With reference to FIGS. 8 and 9, the first fixed installation part 523A and the second fixed installation part 523B are symmetrically positioned on the outer wall of the one-piece spray pipe 521, and are located in the middle of the one-piece spray pipe 521. The positioning part 524 is a long-strip-shaped rib, which protrudes radially outward from the outer wall of the one-piece spray pipe 521 and extends in a longitudinal direction of the one-piece spray pipe 521. The first fixed installation part 523A and the second fixed installation part 523B are distributed on both sides of the positioning part 524. Optionally, only one fixed installation part is provided on the one-piece spray pipe 521, and the positioning part 524 may also be in other suitable forms.

As shown in FIG. 9, in an example, the first and second fixed installation parts 523A, 523B are screw hole structures. However, the fixed installation parts may be any suitable connection structure, such as a snap-fit connection structure, a welded connection structure, and the like.

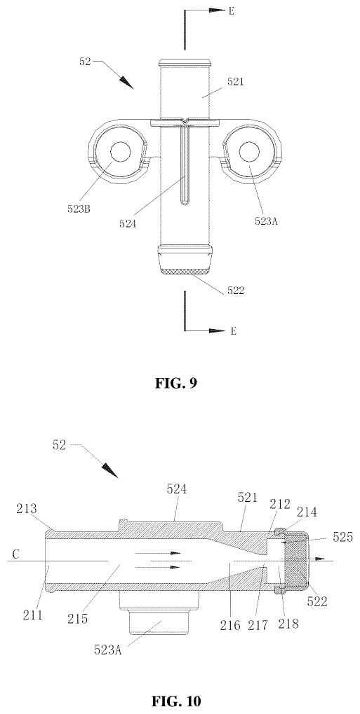

Reference is made to FIG. 10, which is a cross-sectional view of a first example of the micro-bubble spray head in the second embodiment of the present disclosure taken along section line E-E in FIG. 9. As shown in FIG. 10, the micro-bubble spray head 52 includes a one-piece spray pipe 521. The one-piece spray pipe 521 has an inlet end 211 and an outlet end 212. The bubbler 522 is fixed to the outlet end 212. The bubbler 522 may be any hole mesh structure suitable for generating micro-bubbles, such as those listed in the above examples. The bubbler 522 is fixed to the outlet end 212 through a connection part on the outlet end 212. The connection part 214 may be a snap-fit structure, a welded structure, or other suitable connection structures. Optionally, the inlet end 211 is provided with an anti-disengagement rib 213, which protrudes radially outward around the outer wall of the inlet end 211, and which can prevent the micro-bubble spray head from falling off a connected pipeline which provides water supply.

As shown in FIG. 10, a cylindrical part 215, a one-stage diameter-decreased conical part 216, a smallest-diameter opening 217 and an air mixing part 218 are formed in sequence in the passage of the one-piece spray pipe 521 in the water flow direction C. The cylindrical part 215 extends from the inlet end 211 to the one-stage diameter-decreased conical part 216, and an inner diameter of the cylindrical part 215 is equal to a largest inner diameter of the one-stage diameter-decreased conical part 216. The smallest-diameter opening 217 is formed at a top of the one-stage diameter-decreased conical part 216. The smallest-diameter opening 217 communicates with the downstream air mixing part 218. The one-stage diameter-decreased conical part 216 is positioned close to the outlet end 212, and the air mixing part 218 is positioned in the outlet end 212 and adjacent to the bubbler 522. An air passage 525 (shown by the arrow in the figure) is formed directly in an off-center part of the bubbler 522 (i.e., the radially outer part), so the air passage 525 can be regarded as being provided by the radially outer part of the bubbler 522. The water flow enters from the inlet end 211, first flows through the cylindrical part 215, and then flows through the one-stage diameter-decreased conical part 216. The water flow is accelerated in the one-stage diameter-decreased conical part 216, and the accelerated water flow is expanded by the smallest-diameter opening 217 and is sprayed into the air mixing part 218. A negative pressure is generated in the air mixing part 218. Since the air mixing part 218 is close to the bubbler 522, under the action of the negative pressure, the air is sucked from the periphery of the bubbler 522 into the air mixing part 218 and mixes with water to generate bubble water. The bubble water then flows through the bubbler 522 to be cut and mixed by the bubbler 522, thereby generating micro-bubble water. Other parts not mentioned in this example are the same as those in the previous examples.

Optionally, two or more stages of diameter-decreased conical parts may be provided in the one-piece spray pipe 521, and the smallest-diameter opening is formed at a top of the diameter-decreased conical part of a most downstream stage in the water flow direction. The multiple stages of diameter-decreased conical parts can further increase the speed of the water flow, helping to generate more micro-bubbles in the water.

Reference is made to FIG. 11, which is a cross-sectional view of a second example of the micro-bubble spray head in the second embodiment of the present disclosure taken along section line E-E in FIG. 9. As shown in FIG. 11, in this example, the air passage 525 is formed in the radially outer part of the bubbler 522. The outer diameter of bubbler 522 is increased to exceed the outer diameter of the outlet end 212. This design avoids a situation in which the micro-bubble water flowing out of the bubbler blocks most or even all of the mesh holes, allowing more air to be sucked in through the bubbler 522, thereby increasing the number of bubbles in the water. Other parts not mentioned in this example are the same as those in the previous examples.

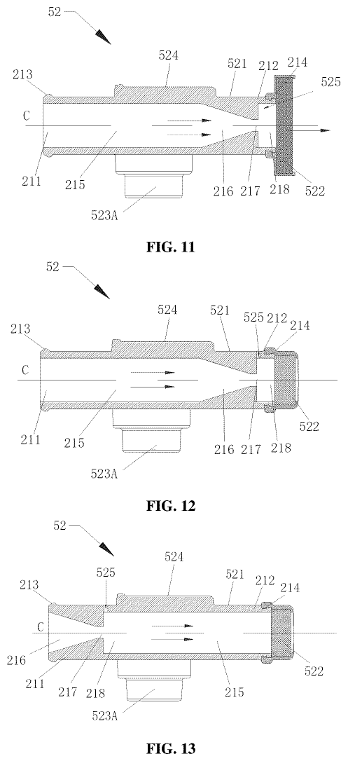

Reference is made to FIG. 12, which is a cross-sectional view of a third example of the micro-bubble spray head in the second embodiment of the present disclosure taken along section line E-E in FIG. 9. As shown in FIG. 12, in this example, the air passage 525 is a through hole formed on the pipe wall of the one-piece spray pipe 521, is positioned at the outlet end 212 and is located downstream of the smallest-diameter opening 217. Other parts not mentioned in this example are the same as those in the previous examples.

Reference is made to FIG. 13, which is a cross-sectional view of a fourth example of the micro-bubble spray head in the second embodiment of the present disclosure taken along section line E-E in FIG. 9. As shown in FIG. 13, the one-stage diameter-decreased conical part 216 is positioned close to the inlet end 211 of the one-piece spray pipe 521. The one-stage diameter-decreased conical part 216, the smallest-diameter opening 217, the air mixing part 218, and the cylindrical part 215 are formed in sequence in the passage of the one-piece spray pipe 521 in the water flow direction C. The air mixing part 218 is a part of the cylindrical part 215. The air passage 525 is a through hole formed on the pipe wall of the one-piece spray pipe 521 and is located close to the inlet end 211. The water flow enters from the inlet end 211, first flows through the one-stage diameter-decreased conical part 216, and is accelerated in the one-stage diameter-decreased conical part 216. The accelerated water flow is expanded by the smallest-diameter opening 217 and is sprayed into the air mixing part 218. A negative pressure is generated in the air mixing part 218. Since the outlet of the through hole (the air passage 525) on the pipe wall is close to the smallest-diameter opening 217, under the action of the negative pressure, the air is sucked into the air mixing part 218 via the through hole on the pipe wall and mixes with water to generate bubble water. The bubble water flows through the cylindrical part 215 and then flows through the bubbler 522. The bubble water is cut and mixed in bubbler 522 to produce micro bubble water. Other parts not mentioned in this example are the same as those in the previous examples.

Optionally, in the example shown in FIG. 13, the one-stage diameter-decreased conical part may be changed to two or more stages of diameter-decreased conical parts, and the smallest-diameter opening is formed at a top of the diameter-decreased conical part of a most downstream stage in the water flow direction. The multiple stages of diameter-decreased conical parts can further increase the speed of the water flow, helping to generate more micro-bubbles in the water.

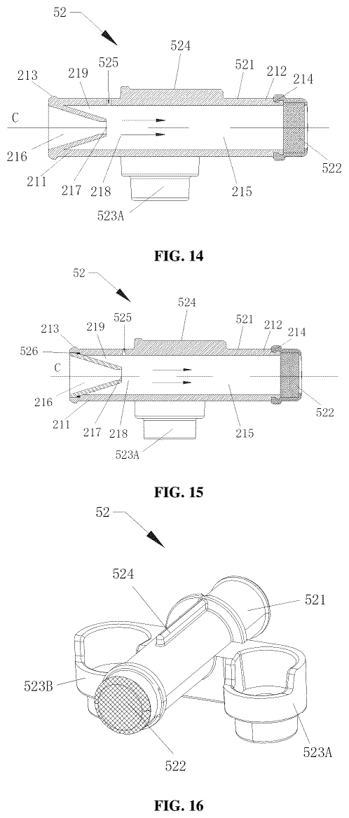

Reference is made to FIG. 14, which is a cross-sectional view of a fifth example of the micro-bubble spray head of the present disclosure taken along section line E-E in FIG. 9. As shown in FIG. 14, in this example, the wall of the one-stage diameter-decreased conical part 216 is separate from the wall of the one-piece spray pipe 219, so that an annular gap 219 is formed between the conical outer wall of the one-stage diameter-decreased conical part 216 and the inner wall of the one-piece spray pipe 219. The annular gap 219 can increase the mixing of air and water. Other parts not mentioned in this example are the same as those in the previous examples.

Reference is made to FIG. 15, which is a cross-sectional view of a sixth example of the micro-bubble spray head of the present disclosure taken along section line E-E in FIG. 9. As shown in FIG. 15, in this example, the one-stage diameter-decreased conical part 216 is a hollow conical varying diameter member which is independent from the one-piece spray pipe 521. The hollow conical varying diameter member 216 can be inserted into the one-piece spray pipe 521 from the inlet end 211. A largest diameter end of the hollow conical varying diameter member 216 is flush with the inlet end 211 and abuts against an annular step formed on the inner wall of the inlet end 211, and the smallest-diameter opening 217 is formed on a smallest diameter end of the hollow conical varying diameter member 216. An annular gap 219 also exists between the conical outer wall of the hollow conical varying diameter member 216 and the inner wall of the one-piece spray pipe 521. A sealing ring 526 is also provided between the hollow conical varying diameter member 216 and the inner wall of the inlet end 211 to prevent water from leaking out between the hollow conical varying diameter member 216 and the inlet end 211. The sealing ring 526 may be made of any suitable sealing material, such as a rubber sealing ring. Other parts not mentioned in this example are the same as those in the previous examples.

### Third Embodiment

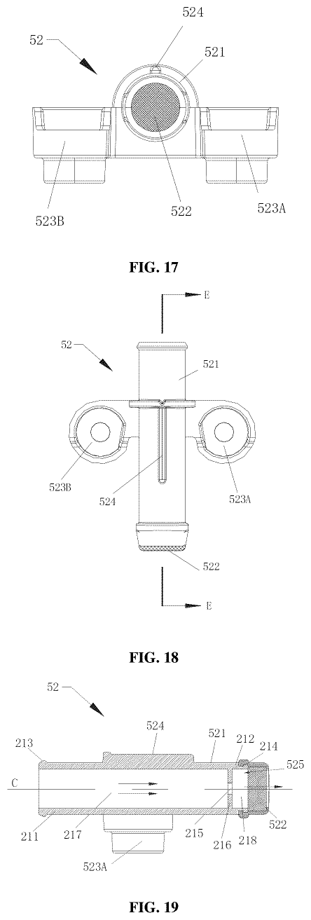

Reference is made to FIGS. 16 to 18, in which FIG. 16 is a schematic perspective view of an example of the micro-bubble spray head in the third embodiment of the present disclosure, FIG. 17 is a front view of an example of the micro-bubble spray head in the third embodiment of the present disclosure shown in FIG. 16, and FIG. 18 is a top view of an example of the micro-bubble spray head in the third embodiment of the present disclosure shown in FIG. 16. As shown in FIGS. 16 to 18, as an example, the micro-bubble spray head 52 of the present disclosure includes a one-piece spray pipe 521. A bubbler 522 is installed at an outlet end of the one-piece spray pipe 521, and the bubbler 522 is a hole mesh structure and is configured to be capable of cutting and mixing the bubble water as it flows through the bubbler 522 so as to produce micro-bubble water containing a large number of micro-bubbles.

Optionally, the hole mesh structure of the bubbler 522 has at least one fine hole having a diameter reaching a micron scale. Preferably, the diameter of the fine hole is between 0 and 1000 microns; more preferably, the diameter of the fine hole is between 5 microns and 500 microns. The hole mesh structure of the bubbler 522 can be a plastic fence, a metal mesh, a macromolecular material mesh, or other suitable hole mesh structures. The plastic fence usually refers to a macromolecular fence, which is integrally injection-molded by using a macromolecular material; or a macromolecular material is first made into a plate, and then a microporous structure is formed on the plate by machining to form the plastic fence. The macromolecular material mesh usually refers to a mesh with a microporous structure made by first making a macromolecular material into wires, and then weaving the wires. The macromolecular material mesh may include nylon mesh, cotton mesh, polyester mesh, polypropylene mesh, and the like. Alternatively, the bubbler 522 may be other hole mesh structures capable of generating micro-bubbles, such as a hole mesh structure composed of two non-micron-scale honeycomb structures.

Optionally, the outer wall of the one-piece spray pipe 521 is provided with a first fixed installation part 523A, a second fixed installation part 523B, and a positioning part 524, which are used to position and fix the micro-bubble spray head 52 to a predetermined position.

With reference to FIGS. 17 and 18, the first fixed installation part 523A and the second fixed installation part 523B are symmetrically positioned on the outer wall of the one-piece spray pipe 521, and are located in the middle of the one-piece spray pipe 521. The positioning part 524 is a long-strip-shaped rib, which protrudes radially outward from the outer wall of the one-piece spray pipe 521 and extends in a longitudinal direction of the one-piece spray pipe 521. The first fixed installation part 523A and the second fixed installation part 523B are distributed on both sides of the positioning part 524. Optionally, only one fixed installation part is provided on the one-piece spray pipe 521, and the positioning part 524 may also be in other suitable forms.

As shown in FIG. 18, in an example, the first and second fixed installation parts 523A, 523B are screw hole structures. However, the fixed installation parts may be any suitable connection structure, such as a snap-fit connection structure, a welded connection structure, and the like.

Reference is made to FIG. 19, which is a cross-sectional view of a first example of the micro-bubble spray head in the third embodiment of the present disclosure taken along section line E-E in FIG. 18. As shown in FIG. 19, the micro-bubble spray head 52 includes a one-piece spray pipe 521. The one-piece spray pipe 521 has an inlet end 211 and an outlet end 212. The bubbler 522 is fixed to the outlet end 212. The bubbler 522 may be any hole mesh structure suitable for generating micro-bubbles, such as those listed in the above examples. The bubbler 522 is fixed to the outlet end 212 through a connection part 214 on the outlet end 212. The connection part 214 may be a snap-fit structure, a welded structure, or other suitable connection structures. Optionally, the inlet end 211 is provided with an anti-disengagement rib 213, which protrudes radially outward around the outer wall of the inlet end 211. After the micro-bubble spray head is connected to a pipeline which provides water supply, the anti-disengagement rib 213 can prevent the micro-bubble spray head from falling off the pipeline which provides water supply. Alternatively, other anti-disengagement structures, such as embedded structures, may be provided on the inlet end 211.

As shown in FIG. 19, a first cylindrical part 217, a radial throttling part 216, a radial throttling hole 215 formed in the radial throttling part 216, and a second cylindrical part 218 are formed in sequence in the passage of the one-piece spray pipe 521 in the water flow direction C. The first cylindrical part 217 extends from the inlet end 211 to the radial throttling part 216 and communicates with the throttling hole 215 on the radial throttling part 216. The second cylindrical part 218 communicates with the throttling hole 215 and extends from the radial throttling part 216 to the outlet end 212. The radial throttling part 216 is positioned close to the outlet end 212, and is adjacent to the bubbler 522. The air passage 525 (shown by the arrow in the figure) is formed directly in an off-center part of the bubbler 522 (i.e., the radially outer part), so the air passage 525 can be regarded as being provided by the radially outer part of the bubbler 522. The water flow enters from the inlet end 211, first flows through the first cylindrical part 217 and then flows through the throttling hole 215 on the radial throttling part 216; the water flow is expanded by the throttling hole 215 and is sprayed into the downstream second cylindrical part 218 to generate a negative pressure in the second cylindrical part 218. Since the second cylindrical part 218 is close to the bubbler 522, under the action of the negative pressure, the air is sucked from the periphery of the bubbler 522 into the second cylindrical part 218 and mixes with water in the second cylindrical part 218 to generate bubble water. The bubble water then flows through the bubbler 522 to be cut and mixed by the bubbler 522, thereby generating micro-bubble water containing a large number of micro-bubbles. Other parts not mentioned in this example are the same as those in the previous examples.

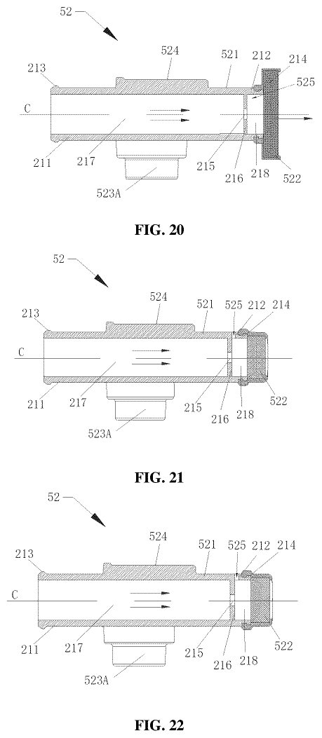

Reference is made to FIG. 20, which is a cross-sectional view of a second example of the micro-bubble spray head in the third embodiment of the present disclosure taken along section line E-E in FIG. 18. As shown in FIG. 20, in this example, the air passage 525 is formed in the radially outer part of the bubbler 522. The outer diameter of bubbler 522 is increased to exceed the outer diameter of the outlet end 212. This design avoids a situation in which the micro-bubble water flowing out of the bubbler blocks most or even all of the mesh holes, allowing more air to be sucked in through the bubbler 522, thereby increasing the number of bubbles in the water. Other parts not mentioned in this example are the same as those in the previous examples.

Reference is made to FIG. 21, which is a cross-sectional view of a third example of the micro-bubble spray head in the third embodiment of the present disclosure taken along section line E-E in FIG. 18. As shown in FIG. 21, in this example, the air passage 525 is a through hole formed on the pipe wall of the one-piece spray pipe 521, is positioned at the outlet end 212 and is located downstream of the throttling hole 215. Other parts not mentioned in this example are the same as those in the previous examples.

Reference is made to FIG. 22, which is a cross-sectional view of a fourth example of the micro-bubble spray head in the third embodiment of the present disclosure taken along section line E-E in FIG. 18. As shown in FIG. 22, the radial throttling part 216 is positioned close to the inlet end 211 of the one-piece spray pipe 521. The first cylindrical part 217, the radial throttling part 216, the radial throttling hole 215 formed in the radial throttling part 216, and the second cylindrical part 218 are formed in sequence in the passage of the one-piece spray pipe 521 in the water flow direction C. The air passage 525 is a through hole formed on the pipe wall of the one-piece spray pipe 521, is positioned close to the inlet end 211 and is located downstream of the throttling hole 215. The water flow enters from the inlet end 211, first flows through the first cylindrical part 217 and then flows through the throttling hole 215 on the radial throttling part 216; the water flow is expanded by the throttling hole 215 and then sprayed into the second cylindrical part 218 to generate a negative pressure in the second cylindrical part 218 near the outlet of the air passage 525. Under the action of the negative pressure, the air is sucked into the second cylindrical part 218 through the air passage (through hole) 525 on the pipe wall and mixes with water in the second cylindrical part 218 to generate bubble water. The bubble water flows through the second cylindrical part 218 and then flows through the bubbler 522. The bubble water is cut and mixed in the bubbler 522, thereby generating micro-bubble water containing a large number of micro-bubbles. Other parts not mentioned in this example are the same as those in the previous examples.

Reference is made to FIG. 23, which is a cross-sectional view of a fifth example of the micro-bubble spray head of the present disclosure taken along section line E-E in FIG. 18. As shown in FIG. 23, in this example, the radial throttling part 216 is replaced by a throttling plate 216′, and the throttling hole 215 is formed on the throttling plate 216′ in the water flow direction C. The throttling plate 216′ is formed independently from the one-piece spray pipe 521. An annular step is formed on the inner wall of the one-piece spray pipe 521, and the throttling plate 216′ faces the outlet end 212 and abuts against the annular step, thereby being embedded in the one-piece spray pipe 521. A sealing ring 526 is also provided between the throttling plate 216′ and the inner wall of the one-piece spray pipe 521 to prevent water from leaking out between the throttling plate 216′ and the inner wall of the one-piece spray pipe 521. The sealing ring 526 may be made of any suitable sealing material, such as a rubber sealing ring. Other parts not mentioned in this example are the same as those in the previous examples.

### Fourth Embodiment

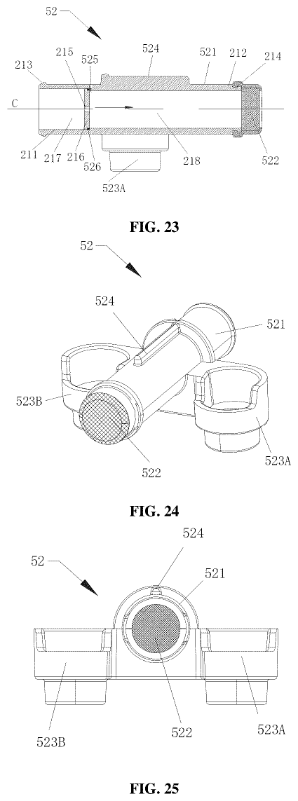

Reference is made to FIGS. 24 to 26, in which FIG. 24 is a schematic perspective view of an example of the micro-bubble spray head in the fourth embodiment of the present disclosure, FIG. 25 is a front view of an example of the micro-bubble spray head in the fourth embodiment of the present disclosure shown in FIG. 24, and FIG. 26 is a top view of an example of the micro-bubble spray head in the fourth embodiment of the present disclosure shown in FIG. 24. As shown in FIGS. 24 to 26, as an example, the micro-bubble spray head 52 of the present disclosure includes a one-piece spray pipe 521. A bubbler 522 is installed at an outlet end of the one-piece spray pipe 521, and the bubbler 522 is a hole mesh structure and is configured to be capable of cutting and mixing the bubble water as it flows through the bubbler 522 so as to produce micro-bubble water containing a large number of micro-bubbles.

Optionally, the hole mesh structure of the bubbler 522 has at least one fine hole having a diameter reaching a micron scale. Preferably, the diameter of the fine hole is between 0 and 1000 microns; more preferably, the diameter of the fine hole is between 5 microns and 500 microns. The hole mesh structure of the bubbler 522 can be a plastic fence, a metal mesh, a macromolecular material mesh, or other suitable hole mesh structures. The plastic fence usually refers to a macromolecular fence, which is integrally injection-molded by using a macromolecular material; or a macromolecular material is first made into a plate, and then a microporous structure is formed on the plate by machining to form the plastic fence. The macromolecular material mesh usually refers to a mesh with a microporous structure made by first making a macromolecular material into wires, and then weaving the wires. The macromolecular material mesh may include nylon mesh, cotton mesh, polyester mesh, polypropylene mesh, and the like. Alternatively, the bubbler 522 may be other hole mesh structures capable of generating micro-bubbles, such as a hole mesh structure composed of two non-micron-scale honeycomb structures.

Optionally, the outer wall of the one-piece spray pipe 521 is provided with a first fixed installation part 523A, a second fixed installation part 523B, and a positioning part 524, which are used to position and fix the micro-bubble spray head 52 to a predetermined position.

With reference to FIGS. 25 and 26, the first fixed installation part 523A and the second fixed installation part 523B are symmetrically positioned on the outer wall of the one-piece spray pipe 521, and are located in the middle of the one-piece spray pipe 521. The positioning part 524 is a long-strip-shaped rib, which protrudes radially outward from the outer wall of the one-piece spray pipe 521 and extends in a longitudinal direction of the one-piece spray pipe 521. The first fixed installation part 523A and the second fixed installation part 523B are distributed on both sides of the positioning part 524.

Optionally, only one fixed installation part is provided on the one-piece spray pipe 521, and the positioning part 524 may also be in other suitable forms.

As shown in FIG. 26, in an example, the first and second fixed installation parts 523A, 523B are screw hole structures. However, the fixed installation parts may be any suitable connection structure, such as a snap-fit connection structure, a welded connection structure, and the like.

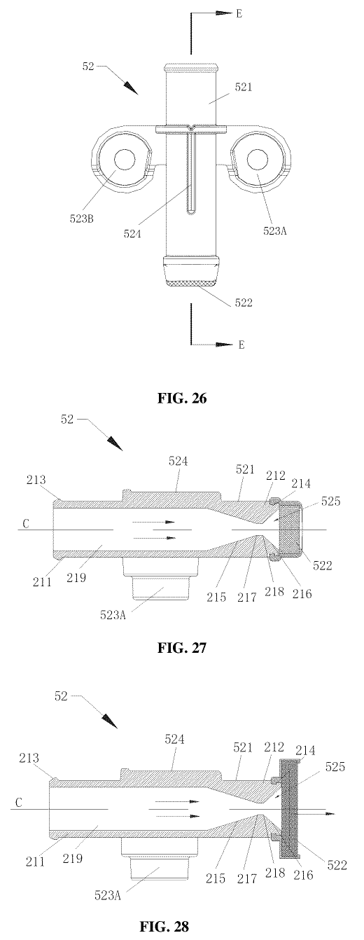

Reference is made to FIG. 27, which is a cross-sectional view of a first example of the micro-bubble spray head in the fourth embodiment of the present disclosure taken along section line E-E in FIG. 26. As shown in FIG. 27, the micro-bubble spray head 52 includes a one-piece spray pipe 521. The one-piece spray pipe 521 has an inlet end 211 and an outlet end 212. The bubbler 522 is fixed to the outlet end 212. The bubbler 522 may be any hole mesh structure suitable for generating micro-bubbles, such as those listed in the above examples. The bubbler 522 is fixed to the outlet end 212 through a connection part 214 on the outlet end 212. The connection part 214 may be a snap-fit structure, a welded structure, or other suitable connection structures. Optionally, the inlet end 211 is provided with an anti-disengagement rib 213, which protrudes radially outward around the outer wall of the inlet end 211, and which can prevent the micro-bubble spray head from falling off a connected pipeline which provides water supply.

As shown in FIG. 27, a cylindrical part 219, a one-stage diameter-decreased conical part 215, a first smallest-diameter opening 217 formed at a smallest-diameter position of the one-stage diameter-decreased conical part 215, a one-stage diameter-increased conical part 216, and a second smallest-diameter opening 218 formed at a smallest-diameter position of the one-stage diameter-increased conical part 216 are formed in sequence between the inlet end 211 and the outlet end 212 in the passage of the one-piece spray pipe 521 in the water flow direction C. The first smallest-diameter opening 217 is closely adjacent to (i.e., a very short distance apart) and communicates with the second smallest-diameter opening 218 to form a throat between the one-stage diameter-decreased conical part 215 and the one-stage diameter-increased conical part 216. The cylindrical part 219 extends from the inlet end 211 to the one-stage diameter-decreased conical part 215, and an inner diameter of the cylindrical part 219 is equal to a largest inner diameter of the one-stage diameter-decreased conical part 215. The one-stage diameter-decreased conical part 215 and the one-stage diameter-increased conical part 216 are positioned close to the outlet end 212, and the one-stage diameter-increased conical part 216 is adjacent to the bubbler 522. An air passage 525 (shown by the arrow in the figure) is provided directly by an off-center part of the bubbler 522 (i.e., the radially outer part), so the air passage 525 can be regarded as being formed in the radially outer part of the bubbler 522. The water flow enters from the inlet end 211, first flows through the cylindrical part 219, and then flows through the one-stage diameter-decreased conical part 215. In the one-stage diameter-decreased conical part 215, the water flow is accelerated due to the narrowing of its flow passage. The accelerated water flow is expanded by the throat formed by the first smallest-diameter opening 217 and the second smallest-diameter opening 218 together, and is sprayed into the one-stage diameter-increased conical part 216. Therefore, a negative pressure is generated in the one-stage diameter-increased conical part 216. Since the one-stage diameter-increased conical part 216 is close to the bubbler 522, under the action of the negative pressure, the air is sucked into the one-stage diameter-increased conical part 216 through the peripheral part of the bubbler 522, and mixes with water in the one-stage diameter-increased conical part 216 to produce bubble water. Due to its gradually increased diameter, the one-stage diameter-increased conical part 216 causes the water flow to be expanded therein gradually, thereby increasing a mixing degree of the air and water. The bubble water is cut and mixed by the bubbler 522 as it flows through the bubbler 522, thereby producing micro-bubble water containing a large number of micro-bubbles. Other parts not mentioned in this example are the same as those in the previous examples.

Optionally, two or more stages of diameter-decreased conical parts can be provided in the one-piece spray pipe 521, and the first smallest-diameter opening is formed at a smallest diameter position of the diameter-decreased conical part of a most downstream stage in the water flow direction. The multiple stages of diameter-decreased conical parts can further increase the speed of the water flow, helping to improve the mixing degree of the air and water and generate more micro-bubbles in the water. In addition, two or more stages of diameter-increased conical parts can also be provided in the one-piece spray pipe 521, and the second smallest-diameter opening is located at a smallest diameter position of the most upstream diameter-increased conical part. The multiple stages of diameter-increased conical parts can further improve the mixing degree of the air and water.

Reference is made to FIG. 28, which is a cross-sectional view of a second example of the micro-bubble spray head of the present disclosure taken along section line E-E in FIG. 26. As shown in FIG. 28, in this example, the air passage 525 is formed in the radially outer part of the bubbler 522. The outer diameter of bubbler 522 is increased to exceed the outer diameter of the outlet end 212. Therefore, the area of the hole mesh structure of the bubbler is increased. This design avoids a situation in which the micro-bubble water flowing out of the bubbler blocks most or even all of the mesh holes, allowing more air to be sucked in through the bubbler 522, thereby increasing the number of bubbles in the water. Other parts not mentioned in this example are the same as those in the previous examples.

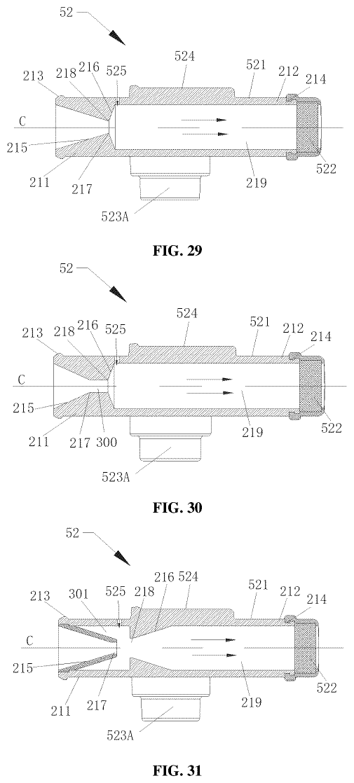

Reference is made to FIG. 29, which is a cross-sectional view of a third example of the micro-bubble spray head of the present disclosure taken along section line E-E in FIG. 26. As shown in FIG. 29, the one-stage diameter-decreased conical part 215 and the one-stage diameter-increased conical part 216 are positioned close to the inlet end 211 of the one-piece spray pipe 521. The one-stage diameter-decreased conical part 215, the first smallest-diameter opening 217 formed at a smallest-diameter position of the one-stage diameter-decreased conical part 215, the one-stage diameter-increased conical part 216, the second smallest-diameter opening 218 formed at a smallest-diameter position of the one-stage diameter-increased conical part 216, and the cylindrical part 219 are formed in sequence in the passage of the one-piece spray pipe 521 in the water flow direction C. The first smallest-diameter opening 217 coincides with the second smallest-diameter opening 218, and a throat is formed between the one-stage diameter-decreased conical part 215 and the one-stage diameter-increased conical part 216. The air passage 525 is an air inflow hole formed on the pipe wall of the one-piece spray pipe 521, and is closely adjacent to a largest diameter position of the one-stage diameter-increased conical part 216. The water flow enters from the inlet end 211, first flows through the one-stage diameter-decreased conical part 215, and is accelerated in the one-stage diameter-decreased conical part 215. The accelerated water flow is expanded by the throat (which is formed by the first smallest-diameter opening 217 and the second smallest-diameter opening 218) and is sprayed into the one-stage diameter-increased conical part 216 and the cylindrical part 219 to generate a negative pressure near the outlet of the air inflow hole 525. Under the action of the negative pressure, the air is sucked into the one-piece spray pipe 521 through the air inflow hole 525 and mixes with water in the one-piece spray pipe 521 to generate bubble water. The bubble water flows through the cylindrical part 219 and then flows through the bubbler 522. The bubble water is cut and mixed in the bubbler 522, thereby producing micro-bubble water containing a large number of micro-bubbles. Other parts not mentioned in this example are the same as those in the previous examples.

Optionally, in the example shown in FIG. 29, the one-stage diameter-decreased conical part may be changed to two or more stages of diameter-decreased conical parts, and the first smallest-diameter opening is formed at a smallest diameter position of the diameter-decreased conical part of a most downstream stage in the water flow direction. The multiple stages of diameter-decreased conical parts can further increase the speed of the water flow, helping to generate more micro-bubbles in the water. In addition, two or more stages of diameter-increased conical parts may also be provided in the one-piece spray pipe 521, and the second smallest-diameter opening is located at a smallest diameter position of the most upstream diameter-increased conical part. The multiple stages of diameter-increased conical parts can further improve the mixing degree of the air and water.

Reference is made to FIG. 30, which is a cross-sectional view of a fourth example of the micro-bubble spray head in the fourth embodiment of the present disclosure taken along section line E-E in FIG. 26. As shown in FIG. 30, in this example, a throttling hole 300 is provided between the first smallest-diameter opening 217 and the second smallest-diameter opening 218. The throttling hole 300 extends from the first smallest-diameter opening 217 to the second smallest-diameter opening 218 and has the same diameter as the first smallest-diameter opening 217 and the second smallest-diameter opening 218. The throttling hole 300 can enhance the expansion effect of the water flow. The air inflow holes (i.e., the air passage 525) are arranged closely adjacent to the largest diameter position of the one-stage diameter-increased conical part 216. Other parts not mentioned in this example are the same as those in the previous examples.

Reference is made to FIG. 31, which is a cross-sectional view of a fifth example of the micro-bubble spray head in the fourth embodiment of the present disclosure taken along section line E-E in FIG. 26. As shown in FIG. 31, in this example, the one-stage diameter-decreased conical part 215 is a hollow conical varying diameter member which is independent from the one-piece spray pipe 521. The hollow conical varying diameter member 215 can be inserted into the one-piece spray pipe 521 from the inlet end 211, and the largest diameter end of the hollow conical varying diameter member 215 is flush with the inlet end 211 and abuts against an annular step formed on the inner wall of the inlet end 211, so as to be embedded in the passage of the one-piece spray pipe. The first smallest-diameter opening 217 is formed at the smallest diameter end of the hollow conical varying diameter member 215. An annular gap 301 exists between the conical outer wall of the hollow conical varying diameter member 215 and the inner wall of the one-piece spray pipe 521. The first smallest-diameter opening 217 and the second smallest-diameter opening 218 are spaced apart by a predetermined distance in the water flow direction C, and the air inflow holes 525 on the pipe wall of the one-piece spray pipe are positioned between the first smallest-diameter opening 217 and the second smallest-diameter opening 218. The gap formed between the first smallest-diameter opening 217 and the second smallest-diameter opening 218 and the annular gap 301 together form an air mixing space. Other parts not mentioned in this example are the same as those in the previous examples.

Optionally, the conical outer wall of the hollow conical varying diameter member 215 as shown in FIG. 31 may be designed as a cylindrical outer wall to match with the inner wall of the one-piece spray pipe 521, whereas the inner wall of the hollow conical varying diameter member 215 still maintains the diameter-decreased conical shape. Therefore, no annular gap 301 will be formed between such a hollow conical varying diameter member and the inner wall of the one-piece spray pipe 521.

### Fifth Embodiment

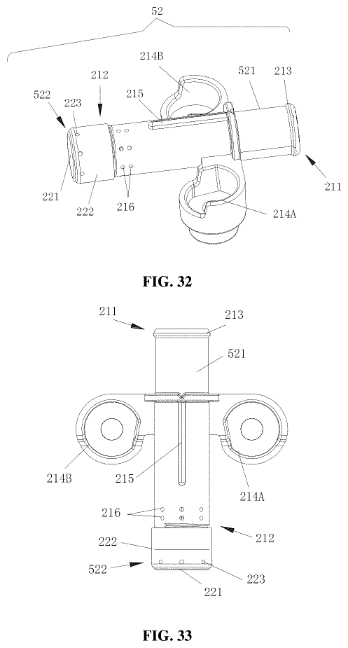

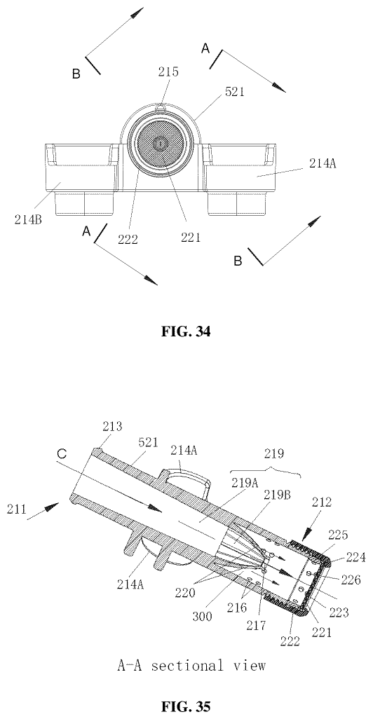

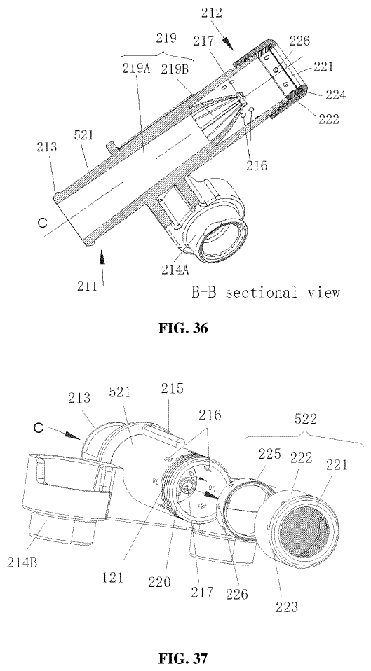

Reference is made to FIGS. 32 to 37, which are schematic views of an example of the micro-bubble spray head in the fifth embodiment of the present disclosure; in which FIG. 32 is a schematic perspective view of the example of the micro-bubble spray head in the fifth embodiment of the present disclosure, FIG. 33 is a top view of the example of the micro-bubble spray head in the fifth embodiment of the present disclosure shown in FIG. 32, FIG. 34 is a front view of the example of the micro-bubble spray head in the fifth embodiment of the present disclosure shown in FIG. 32, FIG. 35 is a cross-sectional view of the example of the micro-bubble spray head in the fifth embodiment of the present disclosure taken along section line A-A in FIG. 34, FIG. 36 is a cross-sectional view of the example of the micro-bubble spray head in the fifth embodiment of the present disclosure taken along section line B-B in FIG. 34, and FIG. 37 is a schematic exploded perspective view of the example of the micro-bubble spray head in the fifth embodiment of the present disclosure. As shown in FIGS. 32 to 37, in one or more examples, the micro-bubble spray head 52 of the present disclosure includes a one-piece spray pipe 521. A bubbler 522 is installed at an outlet end 212 of the one-piece spray pipe 521, and the bubbler 522 is configured to be capable of cutting and mixing the bubble water as it flows through the bubbler 522 so as to produce micro-bubble water containing a large number of micro-bubbles.

Referring to FIG. 32, in one or more examples, the one-piece spray pipe 521 has an inlet end 211 and an outlet end 212. The bubbler 522 is fixed on the outlet end 212, and the inlet end 211 is configured to be connected to an external water source, so that water flow enters the one-piece spray pipe 521 from the inlet end 211, and leaves the one-piece spray pipe 521 from the outlet end 212 through the bubbler 522. Optionally, an anti-disengagement part 213 may be provided on the inlet end 211, such as an anti-disengagement rib protruding radially outward around an outer wall of the inlet end 211 or an annular groove structure recessed inward from the outer wall of the inlet end 211. The anti-disengagement part can prevent the one-piece spray pipe 521 from falling off a connected pipeline which provides water supply.

With continued reference to FIG. 32, in one or more examples, the outer wall of the one-piece spray pipe 521 is provided with a first fixed installation part 214A, a second fixed installation part 214B, and a positioning part 215, which are used to position and fix the micro-bubble spray head 52 to a predetermined position.

With reference to FIGS. 33 and 34, the first fixed installation part 214A and the second fixed installation part 214B are symmetrically positioned on the outer wall of the one-piece spray pipe 521, and are located in the middle of the one-piece spray pipe 521. The positioning part 215 is a long-strip-shaped rib, which protrudes radially outward from the outer wall of the one-piece spray pipe 521 and extends in a longitudinal direction of the one-piece spray pipe 521. The first fixed installation part 214A and the second fixed installation part 214B are distributed on both sides of the positioning part 215. Optionally, only one fixed installation part is provided on the one-piece spray pipe 521, and the positioning part 215 may also be in other suitable forms, such as a cylindrical part extending radially outward.

In one or more examples, the first and second fixed installation parts 214A, 214B are screw hole structures so that the micro-bubble spray head 52 can be fixed to a target position by screws. However, the fixed installation parts may be any suitable connection structure, such as a snap-fit connection structure, a welded connection structure, and the like.

Referring to FIG. 35, a first-stage diameter-decreased conical part 219A and a second-stage diameter-decreased conical part 219B are provided in the one-piece spray pipe 521 in the water flow direction C. A main spray hole 217 is formed at a tip end of the second-stage diameter-decreased conical part 219B. A plurality of auxiliary spray holes 220 are also formed on a circumferential side wall of the second-stage diameter-decreased conical part 219B, and these auxiliary spray holes are arranged around the main spray hole 217. The main spray hole 217 and the auxiliary spray holes 220 communicate the inner passages of the first-stage diameter-decreased conical part 219A and the second-stage diameter-decreased conical part 219B with a downstream passage of the one-piece spray pipe 521. In one or more alternative examples, the at-least-one-stage diameter-decreased conical part 219 may be a one-stage diameter-decreased conical part, or may also be more than two stages of multi-stage diameter-decreased conical part. The main spray hole 217 is always formed at a top end of the diameter-decreased conical part of a most downstream stage in the water flow direction C, and the auxiliary spray holes 220 are formed on a circumferential side wall of the diameter-decreased conical part of the most downstream stage. The main spray hole 217 and the auxiliary spray holes 220 work together, which is not only helpful for sucking more air from the air inflow hole 216 and providing more efficient mixing of the air and water flow, but also can provide the bubbler 522 with a self-cleaning function.

In one or more examples, the main spray hole 217 has a larger diameter than the auxiliary spray holes 220. For example, when the diameter of the main spray hole is 2 mm, the diameter of the auxiliary spray holes 220 may be set to 1 mm.

In one or more examples, the diameter of the main spray hole 217 is in a range of 0-6 mm More preferably, the diameter of the main spray hole is in a range of 1.2-3.5 mm. The diameter of the auxiliary spray holes 220 is in a range of 0-1.2 mm. More preferably, the diameter of the auxiliary spray holes 220 is in a range of 0.5-1 mm.

With continued reference to FIG. 35, a flow disturbing part 218 is formed on an inner wall of the second-stage diameter-decreased conical part 219B. In one or more examples, the flow disturbing part 218 is at least one flow disturbing rib extending longitudinally along the inner wall of this stage of diameter-decreased conical part, such as a plurality of flow disturbing ribs. In an alternative example, the flow disturbing part 218 may be at least one radial protrusion on the inner wall of this stage of diameter-decreased conical part, such as one or more cylindrical protrusions. In an alternative example, the flow disturbing part 218 may also be formed on the first-stage diameter-decreased conical part 219A, or each stage of the diameter-decreased conical part may have a flow disturbing part formed thereon.

As shown in FIG. 35, an outer wall of the second-stage diameter-decreased conical part 219B is separate from the inner wall of the one-piece spray pipe 521, so that an annular gap 300 is formed between the outer wall of the second-stage diameter-decreased conical part 219B and the inner wall of the one-piece spray pipe 521. The annular gap 300 facilitates the mixing of air and water flow, thereby generating more micro-bubbles.

As shown in FIG. 35, the outer wall of the one-piece spray pipe 521 is formed with a plurality of air inflow holes 216 arranged in two rows to form a ring shape. These air inflow holes 216 are all positioned close to the main spray hole 217 and the auxiliary spray holes 220. The water flow enters from the inlet end 211 and first flows through the first-stage diameter-decreased conical part 219A and the second-stage diameter-decreased conical part 219B to accelerate the water flow, whereas the flow disturbing part 218 increases the turbulence of the water flow; the accelerated water flow is expanded and sprayed in multiple streams into the downstream passage of the one-piece spray pipe 521 from the spray hole 217 and the auxiliary spray holes 220, and generates a negative pressure therein; under the action of the negative pressure, a large amount of outside air is sucked into the one-piece spray pipe 521 from the air inflow holes 216 and mix with the multiple streams of water flows in the one-piece spray pipe 521 to produce bubble water. In alternative embodiments, more or fewer air inflow holes may be provided as needed, and they may be arranged in other ways, such as in a staggered arrangement.

With continued reference to FIGS. 33 to 37, the bubbler 522 includes a hole mesh 221 and a hole mesh skeleton 222. The hole mesh 221 is attached to the outlet end 212 of the one-piece spray pipe 521 through the hole mesh skeleton 222.

In one or more examples, the hole mesh 221 has at least one fine hole having a diameter reaching a micron scale. Preferably, the diameter of the fine hole is between 0 and 1000 microns; more preferably, the diameter of the fine hole is between 5 microns and 500 microns. The hole mesh 221 can be a plastic fence, a metal mesh, a macromolecular material mesh, or other suitable hole mesh structures. The plastic fence usually refers to a macromolecular fence, which is integrally injection-molded by using a macromolecular material; or a macromolecular material is first made into a plate, and then a microporous structure is formed on the plate by machining to form the plastic fence. The macromolecular material mesh usually refers to a mesh with a microporous structure made by first making a macromolecular material into wires, and then weaving the wires. The macromolecular material mesh may include nylon mesh, cotton mesh, polyester mesh, polypropylene mesh, and the like. Alternatively, the hole mesh 221 may be other hole mesh structures capable of generating micro-bubbles, such as a hole mesh structure composed of two non-micron-scale honeycomb structures. When the bubble water flows through the hole mesh 221, the hole mesh 221 mixes and cuts the bubble water, thereby generating micro-bubble water.

As shown in FIG. 35, the hole mesh 221 may be configured as a two-layer or multi-layer hole mesh structure. This multi-layer hole mesh structure can help generate more micro-bubbles with a smaller diameter. As shown in FIG. 36, in an alternative example, the hole mesh 221 adopts a single-layer mesh structure.

With continued reference to FIG. 35, the hole mesh skeleton 222 is cylindrical so that it can be sleeved over the outlet end 212 of the one-piece spray pipe 521. In one or more examples, an inner wall of the hole mesh skeleton 222 is provided with internal threads (not shown in the figure) to mesh with external threads 121 (see FIG. 8) on the outer wall of the outlet end 212. Optionally, a gap is reserved between the meshing external threads 121 and internal threads to form a passage allowing air to enter the one-piece spray pipe 521 through the gap. In alternative examples, the hole mesh skeleton 222 may be connected to the outlet end of the one-piece spray pipe 521 by other connection means, such as welding.

As shown in FIG. 35, in one or more examples, the hole mesh skeleton 222 is provided with a plurality of overflow holes 223 along its periphery, and these overflow holes are positioned close to the hole mesh 221. When the bubble water cannot pass through the hole mesh 221 in time, the excess bubble water can flow out from the overflow holes 223, thereby preventing the excess water from flowing back and flooding the air inflow hole 216. Therefore, the overflow holes 223 can prevent a situation in which the air cannot be sucked into the one-piece spray pipe due to the blockage of the air inflow hole so that the micro-bubble water cannot be generated. In alternative examples, more or fewer overflow holes 223 may be provided as needed.

With reference to FIG. 37, in one or more examples, a pressure ring 225 is also provided between the hole mesh skeleton 222 and the outlet end 212 of the one-piece spray pipe 521. Correspondingly, a connection part 224 is provided on the periphery of the hole mesh 221. The pressure ring 225 presses the connection part 224 on the inner wall of the end of the hole mesh skeleton 222, so that the hole mesh 221 can be firmly fixed, and that the hole mesh 221 will not fall off the outlet end 212 of the one-piece spray pipe 521 when it is impacted by high-pressure water flow. In one or more examples, the pressure ring 225 is also provided with a plurality of pressure ring holes 226, and these holes communicate with the overflow holes 223 to discharge excess water.

### Sixth Embodiment

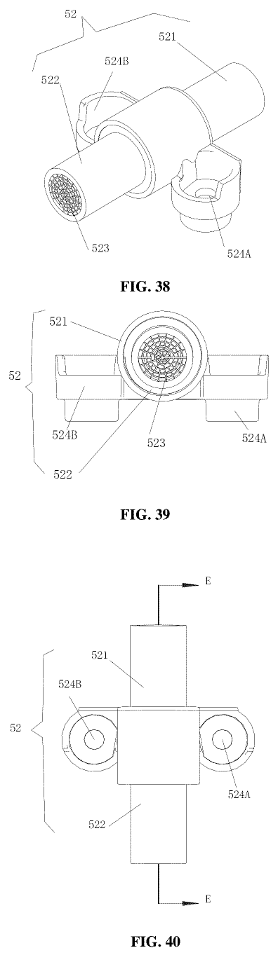

Reference is made to FIGS. 38 to 40, in which FIG. 38 is a schematic perspective view of an example of the micro-bubble spray head in the sixth embodiment of the present disclosure, FIG. 39 is a front view of an example of the micro-bubble spray head in the sixth embodiment of the present disclosure shown in FIG. 38, and FIG. 40 is a top view of an example of the micro-bubble spray head in the sixth embodiment of the present disclosure shown in FIG. 38. As shown in FIGS. 38 to 40, as an example, the micro-bubble spray head 52 of the present disclosure includes a water inflow pipe component 521 and a water outflow pipe component 522. A bubbler 523 is installed at an end of the water outflow pipe component 522, and the bubbler 523 is a hole mesh structure and is configured to be capable of forming micro-bubble water when bubble water passes through the bubbler 523.

Optionally, the hole mesh structure of the bubbler 523 has at least one fine hole having a diameter reaching a micron scale. Preferably, the diameter of the fine hole is between 0 and 1000 microns; more preferably, the diameter of the fine hole is between 5 microns and 500 microns. The hole mesh structure of the bubbler 523 can be a plastic fence, a metal mesh, a macromolecular material mesh, or other suitable hole mesh structures. The plastic fence usually refers to a macromolecular fence, which is integrally injection-molded by using a macromolecular material; or a macromolecular material is first made into a plate, and then a microporous structure is formed on the plate by machining to form the plastic fence. The macromolecular material mesh usually refers to a mesh with a microporous structure made by first making a macromolecular material into wires, and then weaving the wires. The macromolecular material mesh may include nylon mesh, cotton mesh, polyester mesh, polypropylene mesh, and the like. Alternatively, the bubbler 523 may be other hole mesh structures capable of generating micro-bubbles, such as a hole mesh structure composed of two non-micron-scale honeycomb structures.

Optionally, a first fixed installation part 524A and a second fixed installation part 524B are provided on the water inflow pipe component 521.

With reference to FIGS. 39 and 40, the first fixed installation part 524A and the second fixed installation part 524B are symmetrically positioned on both sides of the outer wall of the water inflow pipe component 521, and are located in the middle of the micro-bubble spray head 52 so as to fix the micro-bubble spray head 52 to a predetermined installation position. Optionally, the first and second fixed installation parts 524A and 524B may be provided on the water outflow pipe component 522, or only one fixed installation part is provided on the micro-bubble spray head 52.

As shown in FIG. 40, in an example, the first and second fixed installation parts 524A, 524B are screw hole structures. However, the fixed installation parts may be any suitable connection structure, such as a snap-fit connection structure, a welded connection structure, and the like.

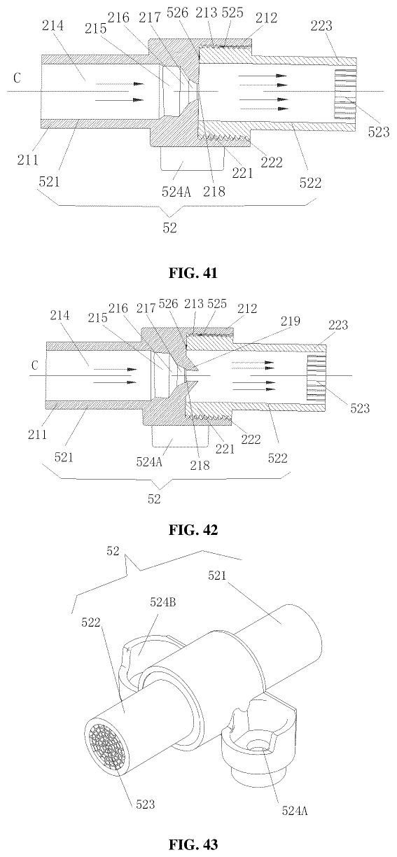

Reference is made to FIG. 41, which is a cross-sectional view of an example of the micro-bubble spray head in the sixth embodiment of the present disclosure taken along section line E-E in FIG. 40. As shown in FIG. 41, the micro-bubble spray head 52 includes a water inflow pipe component 521 and a water outflow pipe component 522.

As shown in FIG. 41, the water inflow pipe component 521 has a water inflow end 211 that allows water to flow in, and a first connection end 212 that allows water to flow out from the water inflow pipe component 521. A first cylindrical part 214, a second cylindrical part 215, a first-stage diameter-decreased conical part 216, a second-stage diameter-decreased conical part 217, and a smallest-diameter opening 218 are formed in sequence in the water inflow pipe component 521 in the water flow direction C. The first cylindrical part 214 extends from the water inflow end 211 to the second cylindrical part 215, and an inner diameter of the first cylindrical part 214 is larger than that of the second cylindrical part 215. The second cylindrical part 215 extends to the first-stage diameter-decreased conical part 216 in the water flow direction C, and the inner diameter of the second cylindrical part 215 is equal to a largest inner diameter of the first-stage diameter-decreased conical part 216. The first-stage diameter-decreased conical part 216 extends to the second-stage diameter-decreased conical part 217 in the water flow direction C, and a smallest inner diameter of the first-stage diameter-decreased conical part 216 is equal to a largest inner diameter of the second-stage diameter-decreased conical part 217. The smallest-diameter opening 218 is formed at a top of the second-stage diameter-decreased conical part 217 to communicate the water inflow pipe component 521 with the water outflow pipe component 522. The first-stage diameter-decreased conical part 216 and the second-stage diameter-decreased conical part 217 are positioned within the first connection end 212. A first engagement part 213 is also formed in the first connection end 212, and the first engagement part 213 is located downstream of the smallest-diameter opening 218 and takes the form of an internal threaded hole wall.

With continued reference to FIG. 41, the water outflow pipe component 522 has a second connection end 221 and a water outflow end 223. The second connection end 221 is located upstream of the water outflow end 223 in the water flow direction C. A second engagement part 222 is provided on the second connection end 221, and the second engagement part 222 is an external threaded cylindrical surface, so that the external threads can mesh with the internal threads of the first engagement part 213. A bubbler 523 capable of generating micro-bubbles is fixed at the water outflow end 223. The bubbler 523 can be any hole mesh structure suitable for generating micro-bubbles, such as those listed in the above examples.

As shown in FIG. 41, in a state where the water inflow pipe component 521 and the water outflow pipe component 522 are assembled, the internal threads of the first engagement part 213 and the external threads of the second engagement part 222 mesh with each other, and an end surface of the second connection end 221 abuts against a radial abutting surface formed in the first connection end 212. The radial abutting surface is flush with a top surface of the second-stage diameter-decreased conical part 217 facing the outflow pipe component 522. A first axial gap 525 (as shown by the arrow pointing to the water inflow pipe component 521 in FIG. 41) is formed between the internal threads and the external threads, and a second radial gap 526 (as shown by the radial arrows in FIG. 41) is formed between the end surface of the second connection end 221 and the abutting surface in the first connection end 212. The first axial gap 525 and the second radial gap 526 communicate with each other to form an air inflow passage. An outlet of the air inflow passage is close to the smallest-diameter opening 218, and is located between the top of the second-stage diameter-decreased conical part 217 and the second connection end 212. After entering the water inflow pipe component 521, the water flows sequentially through the first cylindrical part 214, the second cylindrical part 215, the first-stage diameter-decreased conical part 216 and the second-stage diameter-decreased conical part 217. The second cylindrical part 215, the first-stage diameter-decreased conical part 216 and the second-stage diameter-decreased conical part 217 are configured to increase the speed of the water flow respectively. The accelerated water is expanded by the smallest-diameter opening 218 and is sprayed into the water outflow pipe component 522, thereby forming a negative pressure near the outlet of the air inflow passage; a large amount of outside air is sucked into the water outflow pipe component 522 through the first axial gap 525 and the second radial gap 526 under the action of the negative pressure, and mixes with water to produce bubble water. The bubble water then flows through the bubbler 523 and is cut and mixed by the bubbler 523 to produce micro-bubble water containing a large number of micro-bubbles.

Optionally, a one-stage diameter-decreased conical part is provided in the water inflow pipe component 521, and the smallest-diameter opening is formed at a top of the one-stage diameter-decreased conical part; or three or more stages of diameter-decreased conical parts are formed in the water inflow pipe component 521, and the smallest-diameter opening is formed at a top of the diameter-decreased conical part of the most downstream stage in the water flow direction. In addition, the first cylindrical part 214 and the second cylindrical part 215 may be replaced by a single cylindrical part.

Optionally, the first engagement part 213 of the first connection end 212 is configured as an external threaded cylindrical surface, and the second engagement part 222 of the second connection end 221 is configured as an internal threaded hole wall (not shown in the figure) matching with the external threaded cylindrical surface. An abutting surface is formed in the second connection end 221. In a state where the water inflow pipe component 521 and the water outflow pipe component 522 are assembled, the external threads of the first engagement part 213 of the first connection end 212 mesh with the internal threads of the second engagement part 222 of the second connection end 221, and the end surface of the first connection end 212 abuts against the abutting surface in the second connection end 221. The first axial gap is formed between the meshing external threads and internal threads, and the second radial gap is formed between the end surface and the abutting surface that abut against each other.

Optionally, the first engagement part 213 is a smooth hole wall provided in the first connection end 212, and the second engagement part 222 is a non-smooth cylindrical surface provided on the second connection end 221. The non-smooth cylindrical surface is provided with a plurality of ridges or grooves (not shown in the figure). The first axial gap is formed between the smooth hole wall and the non-smooth cylindrical surface.

Optionally, the first engagement part 213 is a non-smooth hole wall provided in the first connection end 212, which is provided with a plurality of ridges or grooves, and the second engagement part 222 is a smooth cylindrical surface (not shown in the figure) provided on the second connection end 221. The first axial gap is formed between the non-smooth hole wall and the smooth cylindrical surface.

Optionally, the first engagement part 213 is a non-smooth hole wall provided in the first connection end 212, which is provided with a plurality of ridges and/or grooves, and the second engagement part 222 is a non-smooth cylindrical surface provided on the second connection end, which is provided with a plurality of ridges and/or grooves (not shown in the figure). The first axial gap is formed between the non-smooth hole wall and the non-smooth cylindrical surface.

The matching structure of the first engagement part and the second engagement part of the micro-bubble spray head of the present disclosure is not limited to the structures specifically listed above. For example, the matching structure may be a “ridge+ridge” structure, a “groove+groove” structure and a “ridge+groove” structure or other suitable matching structure that can form a reserved gap.

Reference is made to FIG. 42, which is a cross-sectional view of another example of the micro-bubble spray head in the sixth embodiment of the present disclosure taken along section line E-E in FIG. 40. As shown in FIG. 42, an insertion part 219 is formed on a top of the second-stage diameter-decreased conical part 217. The insertion part 219 extends toward an interior of the downstream second connection end 221 around the smallest-diameter opening 218. An outer peripheral surface of the insertion part 219 is a conical surface that gradually contracts in the water flow direction C. The thus-configured insertion part 219 can not only guide the flow of water, but also can prevent the water flow sprayed from the smallest-diameter opening 218 from flowing into the second radial gap 526 and the first axial gap 525 from the outlet of the air inflow passage and further flowing to the outside of the micro-bubble spray head. Other parts not mentioned in this example are the same as those in the previous examples.

### Seventh Embodiment

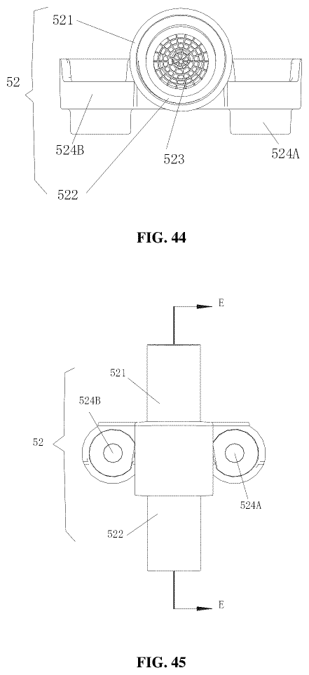

Reference is made to FIGS. 43 to 45, in which FIG. 43 is a schematic perspective view of an example of the micro-bubble spray head in the seventh embodiment of the present disclosure, FIG. 44 is a front view of an example of the micro-bubble spray head in the seventh embodiment of the present disclosure shown in FIG. 43, and FIG. 45 is a top view of an example of the micro-bubble spray head in the seventh embodiment of the present disclosure shown in FIG. 43. As shown in FIGS. 43 to 45, as an example, the micro-bubble spray head 52 of the present disclosure includes a water inflow pipe component 521 and a water outflow pipe component 522. A bubbler 523 is installed at an end of the water outflow pipe component 522, and the bubbler 523 is configured to be capable of forming micro-bubble water by mixing and cutting bubble water when the bubble water passes through the bubbler 523.

Optionally, the bubbler 523 is a hole mesh structure having at least one fine hole having a diameter reaching a micron scale. Preferably, the diameter of the fine hole is between 0 and 1000 microns; more preferably, the diameter of the fine hole is between 5 microns and 500 microns. The hole mesh structure of the bubbler 523 can be a plastic fence, a metal mesh, a macromolecular material mesh, or other suitable hole mesh structures. The plastic fence usually refers to a macromolecular fence, which is integrally injection-molded by using a macromolecular material; or a macromolecular material is first made into a plate, and then a microporous structure is formed on the plate by machining to form the plastic fence. The macromolecular material mesh usually refers to a mesh with a microporous structure made by first making a macromolecular material into wires, and then weaving the wires. The macromolecular material mesh may include nylon mesh, cotton mesh, polyester mesh, polypropylene mesh, and the like. Alternatively, the bubbler 523 may be other hole mesh structures capable of generating micro-bubbles, such as a hole mesh structure composed of two non-micron-scale honeycomb structures.

Optionally, a first fixed installation part 524A and a second fixed installation part 524B are provided on the water inflow pipe component 521.

With reference to FIGS. 44 and 45, the first fixed installation part 524A and the second fixed installation part 524B are symmetrically positioned on both sides of the outer wall of the water inflow pipe component 521, and are located in the middle of the micro-bubble spray head 52 so as to fix the micro-bubble spray head 52 to a predetermined installation position. Optionally, the first and second fixed installation parts 524A and 524B may be provided on the water outflow pipe component 522, or only one fixed installation part is provided on the micro-bubble spray head 52.

As shown in FIG. 45, in an example, the first and second fixed installation parts 524A, 524B are screw hole structures. However, the fixed installation parts may be any suitable connection structure, such as a snap-fit connection structure, a welded connection structure, and the like.

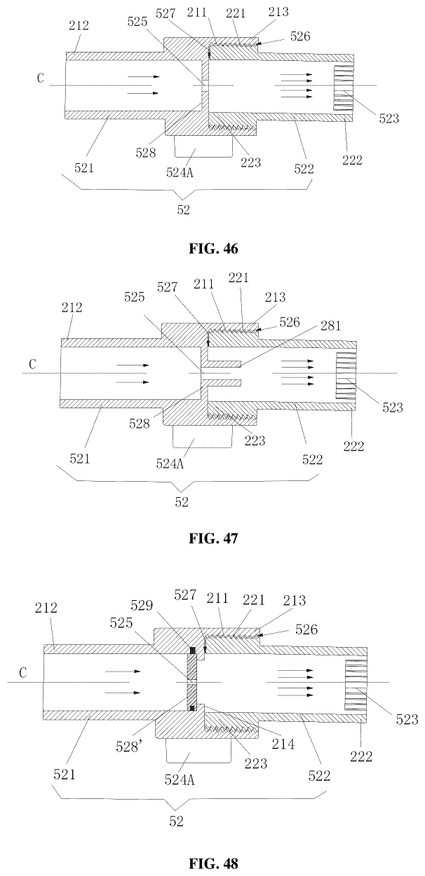

Reference is made to FIG. 46, which is a cross-sectional view of a first example of the micro-bubble spray head in the seventh embodiment of the present disclosure taken along section line E-E in FIG. 45. As shown in FIG. 46, the micro-bubble spray head 52 includes a water inflow pipe component 521 and a water outflow pipe component 522.

As shown in FIG. 46, the water inflow pipe component 521 has a water inflow end 212 that allows water to flow in, and a throttling end 213 that allows water to flow out from the water inflow pipe component 521. The water inflow pipe component 521 is provided therein with a radial throttling part 528 extending inward from an inner wall of the water inflow pipe component 521, and a throttling hole 525 arranged in the water flow direction C is formed on the radial throttling part 528. A first engagement part 211 located downstream of the throttling hole 525 is formed in the throttling end 213, and the first engagement part 211 takes the form of an internal threaded hole wall. With continued reference to FIG. 5, the water outflow pipe component 522 has an air mixing end 223 and a micro-bubble generating end 222. The air mixing end 223 is located upstream of the micro-bubble generating end 222 in the water flow direction. A second engagement part 221 is provided on the air mixing end 223, and the second engagement part 221 is an external threaded cylindrical surface, so that the external threads can mesh with the internal threads of the first engagement part 211. A bubbler 523 capable of generating micro-bubbles is fixed at the micro-bubble generating end 222. The bubbler 523 can be any hole mesh structure suitable for generating micro-bubbles, such as those listed in the above examples.

As shown in FIG. 46, in a state where the water inflow pipe component 521 and the water outflow pipe component 522 are assembled, the internal threads of the first engagement part 213 and the external threads of the second engagement part 222 mesh with each other, and an end surface of the air mixing end 223 abuts against a radial abutting surface formed in the throttling end 213. The radial abutting surface is flush with a side surface of the radial throttling part 528 on a side facing the water outflow pipe component 522. An axial gap 526 is formed between the internal threads and the external threads, and a radial gap 527 is formed between the end surface of the air mixing end 223 and the abutting surface of the throttling end 213. The axial gap 526 and the radial gap 527 communicate with each other to form an air inflow passage, and an outlet of the air inflow passage is close to the throttling hole 525. After the water enters the water inflow pipe component 521 and then flows through the throttling hole 525, under the action of the throttling hole 525, the water is depressurized and expanded, and thus is sprayed into the water outflow pipe component 522 at a high speed, thereby forming a negative pressure near the outlet of the air inflow passage. Under the action of the negative pressure, a large amount of outside air is sucked into the water outflow pipe component 522 through the axial gap 526 and the radial gap 527 and mixes with water in the water outflow pipe component 522 to generate bubble water. The bubble water then flows through the bubbler 523 and is cut and mixed by the bubbler 523 to produce micro bubble water.

Optionally, the first engagement part 211 of the throttling end 213 is configured as an external threaded cylindrical surface, and the second engagement part 221 of the air mixing end 223 is configured as an internal threaded hole wall (not shown in the figure) matching with the external threaded cylindrical surface. An abutting surface is formed in the air mixing end 223. In a state where the water inflow pipe component 521 and the water outflow pipe component 522 are assembled, the external threads of the first engagement part 211 of the throttling end 213 mesh with the internal threads of the second engagement part of the air mixing end 223, and the end surface of the throttling end 213 abuts against the abutting surface in the air mixing end 223. The axial gap is formed between the meshing external threads and internal threads, and the radial gap is formed between the end surface and the abutting surface that abut against each other.

Optionally, the first engagement part 211 is a smooth hole wall provided in the throttling end 213, and the second engagement part 221 is a non-smooth cylindrical surface provided on the air mixing end 223. The non-smooth cylindrical surface is provided with a plurality of ridges or grooves (not shown in the figure). The axial gap is formed between the smooth hole wall and the non-smooth cylindrical surface.

Optionally, the first engagement part 211 is a non-smooth hole wall provided in the throttling end 213, which is provided with a plurality of ridges or grooves, and the second engagement part 221 is a smooth cylindrical surface (not shown in the figure) provided on the air mixing end 223. The axial gap is formed between the non-smooth hole wall and the smooth cylindrical surface.

Optionally, the first engagement part 211 is a non-smooth hole wall provided in the throttling end 213, which is provided with a plurality of ridges and/or grooves, and the second engagement part is a non-smooth cylindrical surface provided on the air mixing end, which is provided with a plurality of ridges and/or grooves (not shown in the figure). The axial gap is formed between the non-smooth hole wall and the non-smooth cylindrical surface.

The matching structure of the first engagement part and the second engagement part of the micro-bubble spray head of the present disclosure is not limited to the structures specifically listed above. For example, the matching structure may be a “ridge+ridge” structure, a “groove+groove” structure and a “ridge+groove” structure or other suitable matching structure that can form a reserved gap.

Optionally, the radial gap 527 formed between the end surface of the air mixing end 223 and the abutting surface of the throttling end 213 is replaced by a radial hole (not shown in the figure) formed on the air mixing end 223. The radial hole extends through a side wall of the air mixing end 223 to communicate with the axial gap 526 and an inner cavity of the air mixing end 223 respectively, so that under the action of the negative pressure created by the throttling hole 525, the air is allowed to be sucked into the inner cavity of the air mixing end 223 through the axial gap 526 and the radial hole.

Reference is made to FIG. 47, which is a cross-sectional view of a second example of the micro-bubble spray head in the seventh embodiment of the present disclosure taken along section line E-E of FIG. 45. As shown in FIG. 47, a cylindrical insertion part 281 is formed on the radial throttling part 528. The insertion part 281 extends toward an interior of the air mixing end 213 of the downstream water outflow pipe component 522 around the throttling hole 525. The insertion part 281 can prevent the water flow sprayed from the throttling hole 525 from flowing into the radial gap 527 and the axial gap 526 from the outlet of the air inflow passage and further flowing to the outside of the micro-bubble spray head. Other parts not mentioned in this example are the same as those in the previous examples.

Reference is made to FIG. 48, which is a cross-sectional view of a third example of the micro-bubble spray head in the seventh embodiment of the present disclosure taken along section line E-E of FIG. 45. As shown in FIG. 48, the throttling hole 525 is formed on a throttling plate 528′ which is independent from the water inflow pipe component 521, and is arranged in the center of the throttling plate 528′ in the water flow direction C. An annular rib 214 extending radially inward is provided in the throttling end 213 of the water inflow pipe component 521. A side face of the annular rib 214 facing the water outflow pipe component 522 is flush with the abutting surface of the throttling hole 213, so the outlet of the air inflow passage is located between the annular rib 214 and the air mixing end 223. The throttling plate 528′ abuts against the annular rib 214 toward the water outflow pipe component 522. A sealing member 529 is also provided between the throttling plate 528′ and the inner wall of the water inflow pipe component 521 to prevent water from bypassing the throttling hole and flowing into the water outflow pipe component 522. The sealing member 529 may be made of any suitable sealing material, such as a rubber sealing ring. Other parts not mentioned in this example are the same as those in the previous examples.

Hitherto, the technical solutions of the present disclosure have been described in connection with the preferred embodiments shown in the accompanying drawings, but it is easily understood by those skilled in the art that the scope of protection of the present disclosure is obviously not limited to these specific embodiments. Without departing from the principles of the present disclosure, those skilled in the art can combine technical features from different embodiments, and can also make equivalent changes or replacements to relevant technical features. All these technical solutions after such changes or replacements will fall within the scope of protection of the present disclosure.

1-66. (canceled)

67. A micro-bubble spray head, comprising:
a spray pipe, which is a one-piece structure, wherein an air inflow passage and an at-least-one-stage diameter-decreased conical part are provided on the spray pipe, and the at-least-one-stage diameter-decreased conical part is configured such that water flow can generate a negative pressure in the spray pipe, and that outside air can be sucked into the spray pipe through the air inflow passage by means of the negative pressure and mix with the water flow in the spray pipe to form bubble water; and
a bubbler, which is fixed at an outlet end of the spray pipe and which is configured to be capable of forming micro-bubble water when the bubble water flows through the bubbler.

68. The micro-bubble spray head according to claim 67,
wherein the at-least-one-stage diameter-decreased conical part is provided in the one-piece spray pipe in a water flow direction, a spray hole is formed at a top of a downstream end of the at-least-one-stage diameter-decreased conical part, and the spray hole is configured such that a water flow flowing through the at-least-one-stage diameter-decreased conical part generates a negative pressure in the one-piece spray pipe after the water flow is sprayed from the spray hole;
a flow disturbing part is provided on an inner wall of the at-least-one-stage diameter-decreased conical part;
at least one air inflow hole is provided on a pipe wall of the one-piece spray pipe, and the at least one air inflow hole is positioned close to the spray hole so that air is sucked into the one-piece spray pipe through the at least one air inflow hole under the action of the negative pressure and mix with the water flow to produce bubble water; and
the bubbler is fixed to the outlet end of the one-piece spray pipe and is configured to be capable of forming micro-bubble water when the bubble water flows through the bubbler.

69. The micro-bubble spray head according to claim 68, wherein the flow disturbing part is positioned on an inner wall of the diameter-decreased conical part of a most downstream stage of the at-least-one-stage diameter-decreased conical part.

70. The micro-bubble spray head according to claim 68, wherein the flow disturbing part is at least one radial protrusion arranged on the inner wall of the at-least-one-stage diameter-decreased conical part or at least one flow disturbing rib extending longitudinally along the inner wall of the at-least-one-stage diameter-decreased conical part.

71. The micro-bubble spray head according to claim 68, wherein the at least one air inflow hole comprises a plurality of air inflow holes arranged in a circumferential direction of the pipe wall of the one-piece spray pipe.

72. The micro-bubble spray head according to claim 68, wherein the bubbler comprises a hole mesh and a hole mesh skeleton, and the hole mesh is attached to the outlet end of the one-piece spray pipe through the hole mesh skeleton.

73. The micro-bubble spray head according to claim 72, wherein the hole mesh skeleton is provided with at least one overflow hole, and the at least one overflow hole is positioned close to the hole mesh; and/or
the hole mesh has at least one fine hole having a diameter reaching a micron scale; and/or
the bubbler further comprises a pressure ring, and the pressure ring is configured to be positioned between the hole mesh skeleton and the outlet end of the one-piece spray pipe to fix the hole mesh.

74. The micro-bubble spray head according to claim 73, wherein the hole mesh comprises plastic fence, metal mesh, or macromolecular material mesh.

75. The micro-bubble spray head according to claim 67, wherein
the one-piece spray pipe comprises a passage formed therein;
the at-least-one-stage diameter-decreased conical part is provided in the passage in a water flow direction, and a smallest-diameter opening is formed at a top of the at-least-one-stage diameter-decreased conical part;
the one-piece spray pipe is also formed with an air passage, and the air passage is positioned close to the smallest-diameter opening so that a negative pressure is formed near an outlet of the air passage when a water flow passes through the smallest-diameter opening, and the negative pressure therefore sucks outside air into the one-piece spray pipe to mix with water and produce bubble water; and
the bubbler is fixed to the outlet end of the one-piece spray pipe and has a hole mesh structure which is configured to be capable of forming micro-bubble water when the bubble water flows through the bubbler.

76. The micro-bubble spray head according to claim 75, wherein the at-least-one-stage diameter-decreased conical part is positioned close to the outlet end, and the air passage is an air inflow hole formed on a pipe wall of the one-piece spray pipe, or is provided by an off-center part of the bubbler.

77. The micro-bubble spray head according to claim 76, wherein the bubbler extends radially beyond an outer diameter of the outlet end to increase the air sucked through the air passage.

78. The micro-bubble spray head according to claim 75, wherein the at-least-one-stage diameter-decreased conical part is positioned close to an inlet end of the one-piece spray pipe, and the air passage is an air inflow hole formed on the pipe wall of the one-piece spray pipe.

79. The micro-bubble spray head according to claim 78, wherein the air passage is located downstream of the smallest-diameter opening; and/or an annular gap is formed between the at-least-one-stage diameter-decreased conical part and an inner wall of the one-piece spray pipe.

80. The micro-bubble spray head according to claim 79, wherein the at-least-one-stage diameter-decreased conical part is a hollow conical varying diameter member which is independent from the one-piece spray pipe, the hollow conical varying diameter member is inserted into the one-piece spray pipe from the inlet end, a largest-diameter end of the hollow conical varying diameter member is flush with and abuts against the inlet end, and the smallest-diameter opening is formed on a smallest-diameter end of the hollow conical varying diameter member.

81. The micro-bubble spray head according to claim 75, wherein the hole mesh structure comprises plastic fence, metal mesh, or macromolecular material mesh; and/or a hole diameter of the hole mesh structure is in a range from 0 to 1000 microns.
